(19) United States
(12) Patent Application Publication
(10) Pub. No.: US 2011/0122176 A1
(43) Pub. Date: May 26, 2011

(54) DISPLAY DEVICE

(76) Inventor: Takaji Numao, Osaka (JP)

(21) Appl. No.: 13/054,278

(22) PCT Filed: Jun. 8, 2009
(86) PCT No.: PCT/JP2009/060447

§ 371 Date: Jan. 14, 2011

(30) Foreign Application Priority Data
Aug. 20, 2008 (JP) 2008-211400

(51) Int. Cl. G09G 5/10; G09G 3/36

(52) U.S. Cl. 345/690; 345/88

(57) ABSTRACT

Transmittances of red, blue and green filters included in a display device are increased, and in a first field period, after a signal voltage (V_{g}) is provided to a green sub-pixel (G), a green CCFL is turned on, whereas red and blue CCFLs are turned off. At this time, only light from the green CCFL transmitted through the green sub-pixel (G) is transmitted through a liquid crystal panel. Also, in a second field period, after signal voltages (Vᵣ and V_{b}) are provided to red and blue sub-pixels (R and B), respectively, the red and blue CCFLs are turned on, and the green CCFL is turned off. At this time, only light from the red and blue CCFLs respectively transmitted through the red and blue sub-pixels (R and B) is transmitted through the liquid crystal panel. Thus, it is possible to provide a display device less susceptible to color purity reduction even if transmittances of color filters are increased.

### TECHNICAL FIELD

The present invention relates to display devices, more specifically to an active-matrix display device capable of color display.

### BACKGROUND ART

In liquid crystal display devices capable of color display, red, green and blue sub-pixels are provided for each pixel and have formed thereon red, green and blue filters respectively transmitting red (R), green (G) and blue (B) light therethrough. FIG. 16 is a graph illustrating transmittance characteristics of red, green and blue filters used in a conventional liquid crystal display device, with the vertical axis representing transmittances and the horizontal axis representing wavelengths of light. As shown in FIG. 16, both the blue and green filters have maximum transmittances of about 80% and the red filter has a higher maximum transmittance, which is above 90%. Also, both the blue and green filters have transmittances of about 50% at wavelengths of around 500 nm, and both the green and red filters have transmittances of about 30% at wavelengths of around 580 nm.

On the other hand, FIG. 17 is a graph illustrating light-emission characteristics of a CCFL (Cold Cathode Fluorescent Lamp) conventionally used as a backlight, with the vertical axis representing transmitted light energy ratios and the horizontal axis representing wavelengths of light from the CCFL. As shown in FIG. 17, energy-ratio peaks are found at blue, green and red wavelengths of around 450 nm, 550 nm and 620 nm, respectively, and significantly they are also found around 500 nm and 600 nm. Accordingly, when the maximum transmittances of the color filters are increased, the transmittances around 500 nm and 600 nm are also increased, resulting in deterioration of color purity. The cause of this is that selective transmission characteristics of the color filters with respect to wavelengths do not abruptly change.

Patent Document 1 discloses a display device having each pixel made up of a sub-pixel C (hereinafter, referred to as a “cyan sub-pixel C”) and a sub-pixel Y (hereinafter, referred to as a “yellow sub-pixel Y”), which have formed thereon their respective cyan and yellow filters respectively transmitting cyan (C) and yellow (Y) light therethrough, the display device displaying color images on a field-sequential system. FIG. 18 is a diagram illustrating pixel arrays made up of cyan and yellow sub-pixels C and Y in a conventional liquid crystal display device, and FIG. 19 provides diagrams illustrating light transmission characteristics for the liquid crystal display device shown in FIG. 18, where (A) a first color filter (not shown) used on a liquid crystal panel included in the liquid crystal display device is on and (B) the first color filter is off. Also, FIG. 20 provides diagrams illustrating light transmission characteristics for the liquid crystal display device shown in FIG. 18, where (A) a second color filter (not shown) used on the liquid crystal panel included in the liquid crystal display device is on and (B) the second color filter is off. As shown in FIG. 19, the first color filter transmits green light therethrough when it is on and transmits red, green and blue light therethrough when it is off. Also, as shown FIG. 20, the second color filter transmits red and blue light therethrough when it is on and transmits red, green and blue light therethrough when it is off.

In period t₁, the first color filter is turned on, and the second color filter is turned off. In period t₂, inversely, the first color filter is turned off, and the second color filter is turned on.

When cyan (a color obtained by mixing blue and green at a ratio of 1 to 1) light, which can be transmitted through the cyan sub-pixel C, is transmitted through the first and second color filters, it turns green in period t₁ and blue in period t₂. On the other hand, yellow (a color obtained by mixing red and green at a ratio of 1 to 1) light, which can be transmitted through the yellow sub-pixel Y, turns green in period t₁ and red in period t₂. That is, in period t₁, both the cyan sub-pixel C and the yellow sub-pixel Y display green, and in period t₂, the cyan sub-pixel C displays blue while the yellow sub-pixel Y displays red.

In this manner, the display device alternatingly turns on the first and second color filters, thereby allowing image display on the field-sequential system which alternates transmission of green light and red and blue light.

### Citation List

### Patent Document

[Patent Document 1] Japanese Laid-Open Patent Publication No. 2005-10510

### DISCLOSURE OF THE INVENTION

### Problems to be Solved by the Invention

In order not to increase the transmittance at around 500 nm and 600 nm when the maximum transmittance of the color filter is increased, it is necessary to enhance the selective transmission characteristics of the color filter. To this end, however, a novel material needs to be developed.

On the other hand, even if the selective transmission characteristics of the color filter are not enhanced, displaying color images on the field-sequential system does not cause deterioration of color purity, but it is necessary to use fast-response liquid crystals such as OCB (Optically Compensated Bend) liquid crystals. Besides, such fast-response liquid crystals have not yet been fully confirmed in their reliability.

The technology described in Patent Document 1 has a problem in that, since the cyan sub-pixel Y displays green and blue and the yellow sub-pixel Y displays green and red, for example, when ambient temperature decreases, so that the response speed of the liquid crystal decreases, color mixing occurs, rapidly reducing the color purity. In this case, by using liquid crystals capable of fast response, such as OCB liquid crystals, it is possible to improve the reduced color purity. However, if the ambient temperature further decreases, even the response speed of liquid crystals capable of fast response is reduced, and therefore color purity reduction is inevitable.

Therefore, an objective of the present invention is to provide a display device resistant to color purity reduction even when transmittances of color filters are increased.

### Means for Solving the Problems

A first aspect of the present invention is directed to an active-matrix display device capable of color display, comprising:

a display portion having a plurality of display elements arranged in a matrix, the display elements each having a plurality of types of color filters formed thereon to transmit light therethrough with a transmittance corresponding to a provided signal voltage;

a drive control portion for providing a signal voltage to the display elements having formed thereon the color filters of at least one of the types, in each of a plurality of field periods, each including first and second field periods, obtained by dividing a frame period in which to provide a display for one screen;

a backlight portion including a plurality of light emitters provided for their respective types of the color filters to emit light in a plurality of colors, the backlight portion irradiating the display portion with light by turning on the light emitters to emit light in at least one color; and

a backlight control portion for controlling the light emitters to be turned on and off independently of each other, wherein,

the color filters include first, second and third color filters, the second color filter transmitting therethrough light of shorter wavelengths than are transmitted by the first color filter and also light of some wavelengths overlapping with those transmitted by the first color filter, the third color filter transmitting therethrough light of longer wavelengths than are transmitted by the first color filter and also light of some wavelengths overlapping with those transmitted by the first color filter,

the backlight portion includes first, second and third light emitters corresponding to the first, second and third color filters, respectively,

the drive control portion provides a signal voltage to the first display element having the first color filter formed thereon in the first field period and to the second and third display elements respectively having the second and third color filters formed thereon in the second field period, and

the backlight control portion turns on the first light emitter, with the second and third light emitters being turned off, in the first field period and turns on the second and third light emitters, with the first light emitter being turned off, in the second field period.

In a second aspect of the present invention, based on the first aspect of the invention,

the display element has a function of blocking light from the light emitter when a predetermined voltage is applied thereto,

in the first field period, the drive control portion provides a signal voltage to the first display element and a light-blocking voltage to the second and third display elements,

in the second field period, the drive control portion provides a signal voltage to the second and third display elements and a light-blocking voltage to the first display element,

the backlight control portion turns on the first light emitter after a signal voltage is provided to the first display element and a voltage for blocking light from the first light emitter is provided to the second and third display elements, and

the backlight control portion turns on the second and third light emitters after a signal voltage is provided to the second and third display elements and a voltage for blocking light from the second and third light emitters is provided to the first display element.

In a third aspect of the present invention, based on the second aspect of the invention, the first to third color filters are green, red and blue filters, respectively, and the first to third light emitters are cold-cathode tubes for emitting green, red and blue light, respectively.

In a fourth aspect of the present invention, based on the third aspect of the invention, the first color filter is a colorless and transparent filter.

In a fifth aspect of the present invention, based on the first aspect of the invention,

the display element has a function of blocking light from the light emitter when a predetermined voltage is applied thereto,

in the first field period, the drive control portion provides a signal voltage to the first display element in accordance with a part of a data signal that should be originally displayed by the first display element and a signal voltage to at least one of the second and third display elements in accordance with the rest of the data signal,

in the second field period, the drive control portion provides a signal voltage to the second and third display elements and a light-blocking voltage to the first display element,

the backlight control portion turns on the first light emitter after a signal voltage is provided to the first display element in accordance with a part of the data signal and a signal voltage is provided to at least one of the second and third display elements in accordance with the rest of the data signal, and

the backlight control portion turns on the second and third light emitters after a signal voltage is provided to the second and third display elements and the light-blocking voltage is provided to the first display element.

In a sixth aspect of the present invention, based on the fifth aspect of the invention, in the first field period, the drive control portion provides a signal voltage to the first display element in accordance with the part of the data signal and also provides a signal voltage to the second display element in accordance with the rest of the data signal when chromaticity coordinates of a color represented by the data signal are in a first area approximately at the same distance from chromaticity coordinates of first and second colors within a triangle having vertices at chromaticity coordinates of white, the chromaticity coordinates of the first color and the chromaticity coordinates of the second color, or a signal voltage to the third display element in accordance with the rest of the data signal when the chromaticity coordinates of the color represented by the data signal are in a second area approximately at the same distance from the chromaticity coordinates of the first color and chromaticity coordinates of a third color within a triangle having vertices at the chromaticity coordinates of white, the chromaticity coordinates of the first color and the chromaticity coordinates of the third color.

In a seventh aspect of the present invention, based on the fifth aspect of the invention, the signal voltage in accordance with the part of the data signal is higher than the signal voltage in accordance with the rest of the data signal.

In a eighth aspect of the present invention, based on the fifth aspect of the invention, the first to third color filters are green, red and blue filters, respectively, and the first to third light emitters are green, red and blue LED lamps, respectively, having a plurality of green, red and blue light-emitting diodes arranged therein.

In a ninth aspect of the present invention, based on the eighth aspect of the invention, the first color filter is a colorless and transparent filter.

In a tenth aspect of the present invention, based on the first aspect of the invention,

the display element has a function of blocking the light from the light emitter when a predetermined voltage is applied thereto,

the first color filter transmits therethrough all light transmitted through the second color filter and a part of light at wavelengths transmitted through the third color filter,

in the first field period, the drive control portion provides a signal voltage to the first display element and a light-blocking voltage to the second and third display elements,

in the second field period, the drive control portion provides a signal voltage to the second display element, a signal voltage to the third display element in accordance with a part of a data signal that should be originally displayed by the third display element, and a signal voltage to the first display element in accordance with the rest of the data signal,

the backlight control portion turns on the first light emitter after a signal voltage is provided to the first display element and a voltage for blocking light from the first light emitter is provided to the second and third display elements, and

the backlight control portion turns on the second and third light emitters after a signal voltage is provided to the second display element, a signal voltage is provided to the third display element in accordance with a part of the data signal, and a signal voltage is provided to the first display element in accordance with the rest of the data signal.

In a eleventh aspect of the present invention, based on the tenth aspect of the invention, the signal voltage in accordance with the part of the data signal is higher than the signal voltage in accordance with the rest of the data signal.

In a twelfth aspect of the present invention, based on the tenth aspect of the invention, the first to third color filters are cyan, red and blue filters, respectively, and the first to third light emitters are green, red and blue LED lamps, respectively, having a plurality of green, red and blue light-emitting diodes arranged therein.

In a thirteenth aspect of the present invention, based on the twelfth aspect of the invention, the green, red and blue LED lamps have the green, red and blue light-emitting diodes provided in a delta arrangement.

In a fourteenth aspect of the present invention, based on any one of the second, fifth and tenth aspect of the invention, the backlight control portion turns off the second and third light emitters before turning on the first light emitter, and the backlight control portion turns off the first light emitter before turning on the second and third light emitters.

In a fifteenth aspect of the present invention, based on any one of the second, fifth and tenth aspect of the invention, the backlight portion is divided into a plurality of blocks, each including one from each of the first to third light emitters, the blocks being partitioned by partition plates.

In a sixteenth eleventh aspect of the present invention, based on the first aspect of the invention, a range of wavelengths transmitted through the second color filter overlaps a range of wavelengths transmitted through the third color filter with a minimum manufacturable width.

### Effect of the Invention

According to the first aspect of the present invention, in the first field period, after a signal voltage is provided to the first display element having the first color filter formed thereon, the first light emitter for emitting light in a color corresponding to the first color filter is turned on and the second and third light emitters for emitting light in their respective colors corresponding to the second and third color filters are turned off. Also, in the second field period, after a signal voltage is provided to the second and third display elements respectively having the second and third color filters formed thereon, the second and third light emitters are turned on and the first light emitter is turned off. In this case, in the first field period, the first display element transmits therethrough light from the first light emitter but no light from the second and third light emitters. On the other hand, in the second field period, the second and third display elements respectively transmit therethrough light from the second and third light emitters but no light from the first light emitter. Thus, it is possible to suppress color purity reduction in both field periods. Also, by increasing the transmittances of the color filters, the luminance of the display portion can be kept high even if emission intensities of the light emitters are reduced, making it possible to achieve low power consumption of the backlight portion.

According to the second aspect of the present invention, in the first field period, after a signal voltage is provided to the first display element and a light-blocking voltage is provided to the second and third display elements, the first light emitter is turned on. Also, in the second field period, after a signal voltage is provided to the second and third display elements and a light-blocking voltage is provided to the first display element, the second and third light emitters are turned on. In this case, in the first field period, light from the first light emitter is transmitted through the first display element but is not transmitted through the second and third display elements. Also, in the second field period, light from the second and third light emitters is transmitted through the second and third display elements, respectively, but is not transmitted through the first display element. Thus, it is possible to suppress color purity reduction.

According to the third aspect of the present invention, cold-cathode tubes of the same colors as the color filters are used as light emitters, and therefore it is possible to effectively use light from the cold-cathode tubes.

According to the fourth aspect of the present invention, the first color filter is a colorless and transparent filter, and therefore it is possible to keep color filter production cost low.

According to the fifth aspect of the present invention, in the first field period, the first light emitter is turned on after a signal voltage is provided to the first display element in accordance with a part of the data signal that should be originally displayed by the first display element and a signal voltage is provided to at least one of the second and third display elements in accordance with the rest of the data signal. As a result, light from the first light emitter is transmitted through not only the first display element but also at least one of the second and third display elements. Moreover, in the second field period, the second and third light emitters are turned on after a signal voltage is provided to the second and third display elements and a light-blocking voltage is provided to the first display element. As a result, light from the second and third light emitters is transmitted through the second and third display elements, respectively, but is not transmitted through the first display element. In this manner, in the first field period, light from the first light emitter is transmitted through not only the first display element but also the second and third display elements. In this case, use efficiency of light from the first light emitter is increased, and therefore even if the emission intensity of the first light emitter is reduced, the luminance of the display portion can be kept high, making it possible to achieve low power consumption of the backlight portion. Also, in the second field period, color purity reduction can be suppressed.

According to the sixth aspect of the present invention, in the first field period, a signal voltage is provided to the first display element in accordance with a part of the data signal that should be originally displayed by the first display element. Also, in the case where chromaticity coordinates represented by the data signal that should be originally displayed by the first display element are in the first area, a signal voltage is provided to the second display element in accordance with the rest of the data signal, and then, the first light emitter is turned on. On the other hand, in the case where the chromaticity coordinates represented by the data signal that should be originally displayed by the first display element are in the second area, a signal voltage is provided to the third display element in accordance with the rest of the data signal, and then, the first light emitter is turned on. In this case, it is possible to use the first LED lamp more efficiently without narrowing the color reproduction range.

According to the seventh aspect of the present invention, the signal voltage provided to the first display element is higher than the signal voltage provided to the second and third display elements, and therefore the transmittance of the first display element becomes higher than the transmittances of the second and third display elements. Consequently, light from the first light emitter is mainly transmitted through the first display element, and therefore it is possible to minimize the rate of light from the first light emitter being transmitted through the second and third display elements. Thus, it is possible to further suppress color purity reduction.

According to the eighth aspect of the present invention, LED lamps of the same colors as the color filters are used as light emitters, and therefore it is possible to effectively use light from the LED lamps.

According to the ninth aspect of the present invention, the first color filter is a colorless and transparent filter, and therefore it is possible to keep color filter production cost low.

According to the tenth aspect of the present invention, in the first field period, after a signal voltage is provided to the first display element and a light-blocking voltage is provided to the second and third display elements, the first light emitter is turned on. Accordingly, light from the first light emitter is transmitted only through the first display element, and therefore it is possible to suppress color purity reduction. Also, in the second field period, after a signal voltage is provided to the second display element, a signal voltage is provided to the third display element in accordance with a part of the display data that should be originally displayed by the third display element, and a signal voltage is provided to the first display element in accordance with the rest of the display data, the second and third light emitters are turned on. Accordingly, light from the second and third light emitters is transmitted through the second and third display elements, and also part of the light from the third light emitter is transmitted through the first display element. In this manner, in the second field period, by providing the first display element with a part of the signal voltage that should be originally provided to the third display element, light from the third display element is transmitted through not only the third display element but also the first display element. In this case, use efficiency of light from the third light emitter is increased, and therefore even if the emission intensity of the third light emitter is reduced, the luminance of the display portion can be kept high, making it possible to achieve low power consumption of the backlight portion.

According to the eleventh aspect of the present invention, the signal voltage provided to the third display element is higher than the signal voltage provided to the first display element, and therefore the transmittance of the third display element becomes higher than the transmittance of the first display element. Consequently, light from the third light emitter is mainly transmitted through the third display element, and therefore it is possible to minimize the rate of light from the third light emitter being transmitted through the first display element. Thus, it is possible to further suppress color purity reduction.

According to the twelfth aspect of the present invention, LED lamps of the same colors as the red and blue filters are used as light emitters, and therefore it is possible to effectively use light from the LED lamps. Also, cyan is a color obtained by mixing blue and green at the same rate, and therefore light from not only the green LED lamp but also the blue LED lamp is transmitted. Thus, it is possible to effectively use light from the blue LED lamp.

According to the thirteenth aspect of the present invention, the green, red and blue LED lamps have light-emitting diodes provided in a delta arrangement to emit light in their respective colors. In this case, the light-emitting diodes are almost uniformly arranged in the backlight portion, and therefore the display elements can be irradiated with light in the colors at almost uniform emission intensities.

According to the fourteenth aspect of the present invention, the second and third light emitters are turned off before the first light emitter is turned on, and the first light emitter is turned off before the second and third light emitters are turned on, so that light from the first light emitter is not transmitted through any of the first to third display elements at the same time as light from the second and third light emitters. Thus, it is possible to prevent color purity reduction.

According to the fifteenth aspect of the present invention, the backlight portion is divided into a plurality of blocks, and the first, second and third light emitters are provided in each block. Thus, display elements in the blocks are almost uniformly irradiated with light from the light emitters. Also, the blocks are partitioned by the partition plates, and therefore display elements in the blocks are not irradiated with light from light emitters in any adjacent blocks. Thus, it is possible to suppress color purity reduction while preventing display quality reduction.

According to the sixteenth aspect of the present invention, the range of wavelengths transmitted through the second color filter overlaps the range of wavelengths transmitted through the third color filter with a minimum manufacturable width, and therefore, even if the second and third light emitters are turned on at the same time, fewer of the light from the second light emitter and the third light emitter is transmitted through the third color filter and the second color filter, respectively. Thus, it is possible to further suppress color purity reduction.

### BRIEF DESCRIPTION OF THE DRAWINGS

FIG. 1 provides diagrams illustrating (A) an arrangement of red, green and blue filters on a liquid crystal panel, (B) the relationship between the transmittance and the wavelength for the red, green and blue filters, and (C) the relationship between the transmittance and the wavelength for the filters shown in (B) where they are placed on one another.

FIG. 2 is a block diagram illustrating the configuration of a liquid crystal display device according to a first embodiment of the present invention.

FIG. 3 is a diagram illustrating equivalent circuits of display elements 17 respectively functioning as red, green and blue sub-pixels.

FIG. 4 is a diagram illustrating the configuration of a backlight unit used in the liquid crystal display device shown in FIG. 2.

FIG. 5 is a timing chart illustrating the relationship between the on/off timing of the backlight unit shown in FIG. 4 and signal voltages provided to sub-pixels.

FIG. 6 is a chromaticity diagram for the XYZ color system.

FIG. 7 is a graph illustrating spectral distribution for light emitted by a red CCFL. FIG. 8 is a graph illustrating spectral distribution for light emitted by a green CCFL.

FIG. 9 is a graph illustrating spectral distribution for light emitted by a blue CCFL.

FIG. 10 is a diagram illustrating the configuration of a backlight unit used in a liquid crystal display device according to a second embodiment.

FIG. 11 is a timing chart illustrating the relationship between the on/off timing of the backlight unit shown in FIG. 10 and signal voltages provided to sub-pixels.

FIG. 12 is a graph illustrating the relationship between the wavelength and the emission intensity of light emitted by red, green and blue LEDs included in an LED light source.

FIG. 13 is a chromaticity diagram describing a variant of the second embodiment.

FIG. 14 provides diagrams for a liquid crystal display device according to a third embodiment, illustrating (A) an arrangement of filters formed on sub-pixels, (B) the relationship between the transmittance and the wavelength for the filters provided on the sub-pixels, and (c) the relationship between the transmittance and the wavelength for the filters shown in (B) where they are placed on one another.

FIG. 15 is a timing chart illustrating the relationship between the on/off timing of a backlight unit used in the liquid crystal display device according to the third embodiment and signal voltages provided to sub-pixels.

FIG. 16 is a graph illustrating transmittance characteristics of red, green and blue filters used in a conventional liquid crystal display device.

FIG. 17 is a graph illustrating light-emission characteristics of a CCFL conventionally used as a liquid crystal display device backlight.

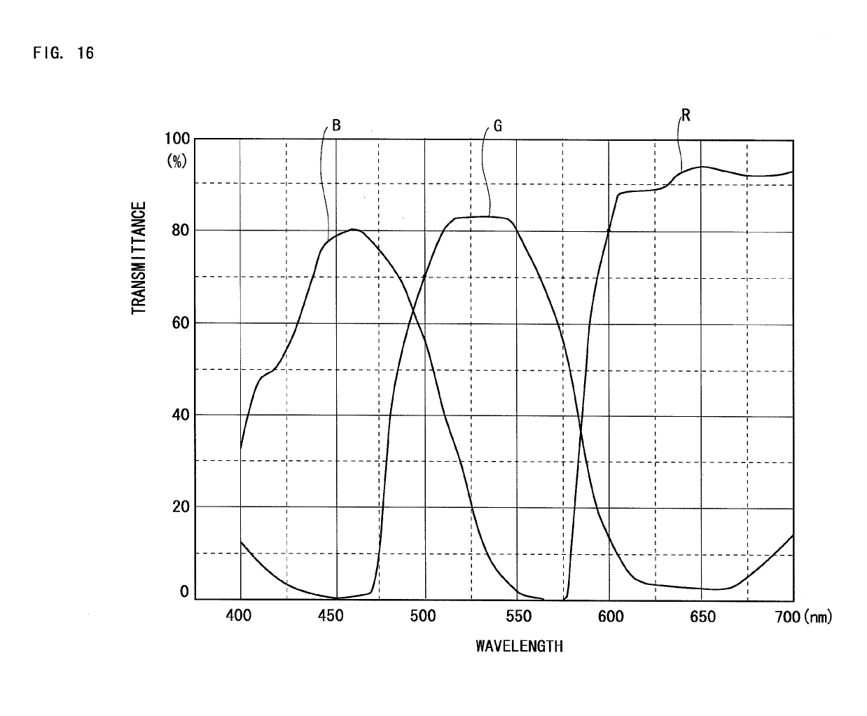

FIG. 18 is a diagram illustrating pixel arrays made up of cyan and yellow sub-pixels C and Y in a conventional liquid crystal display device.

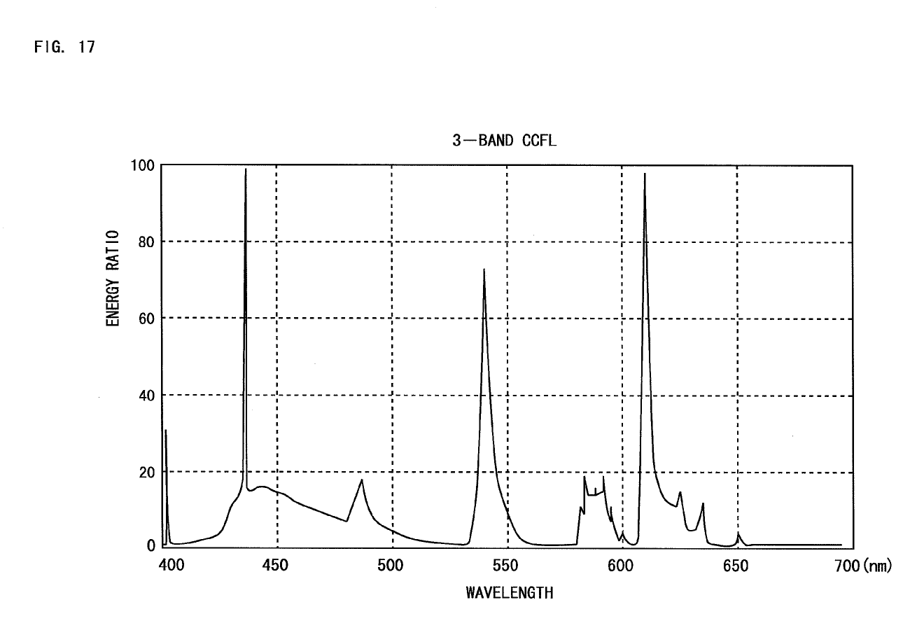

FIG. 19 provides diagrams illustrating light transmission characteristics for the liquid crystal display device shown in FIG. 18, where (A) a first color filter is on and (B) the first color filter is off.

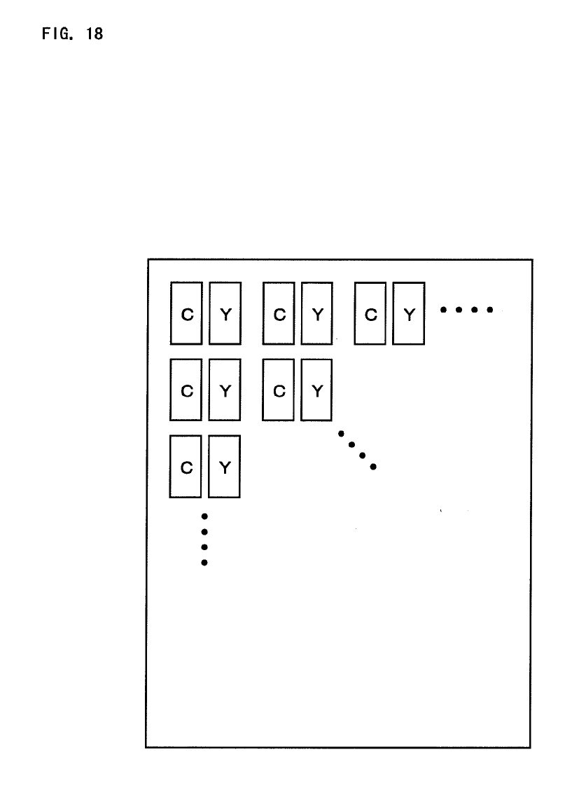

FIG. 20 provides diagrams illustrating light transmission characteristics for the liquid crystal display device shown in FIG. 18, where (A) a second color filter is on and (B) the second color filter is off.

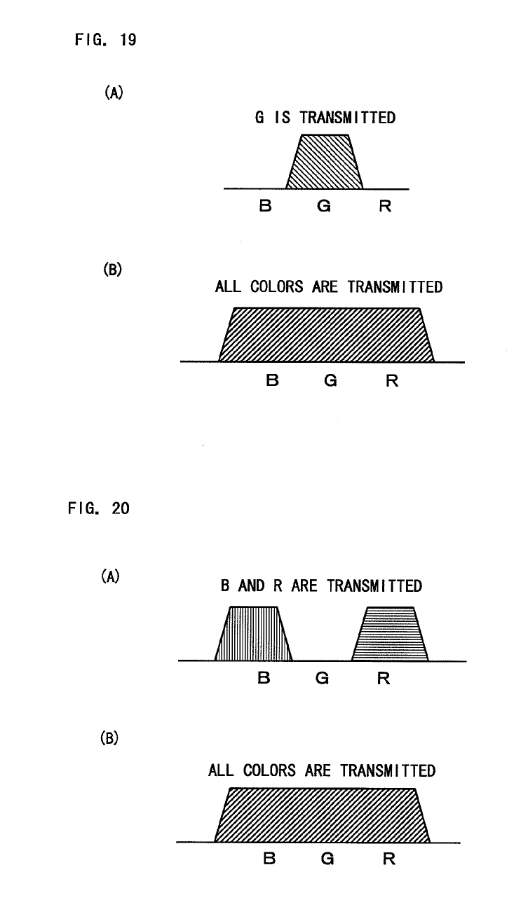

### MODE FOR CARRYING OUT THE INVENTION

### 1. Basic Study

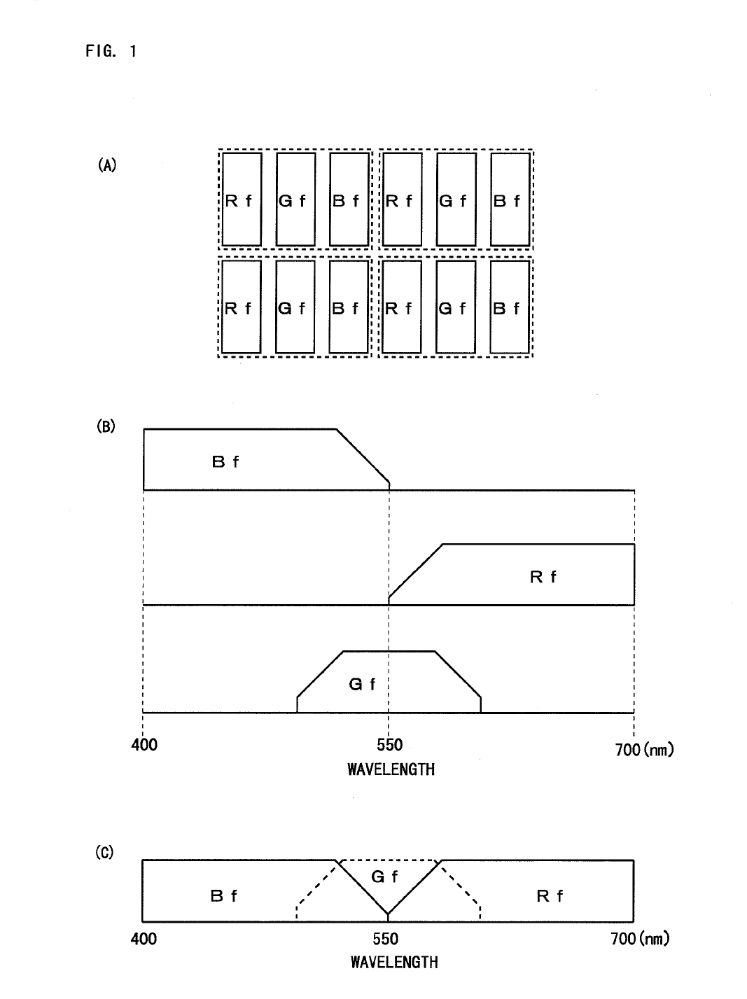

Before describing embodiments of the present invention, a basic study of the present invention will be provided with reference to FIG. 1. FIG. 1 provides diagrams illustrating (A) an arrangement of red, green and blue filters Rf, Gf and Bf on a liquid crystal panel, (B) the relationship between the transmittance and the wavelength for the red, green and blue filters Rf, Gf and Bf, and (C) the relationship between the transmittance and the wavelength for the filters Rf, Gf and Bf shown in (B) where they are placed on one another.

As shown in FIG. 1(A), the liquid crystal panel has formed thereon a plurality of pixels, each including red, green and blue sub-pixels R, G and B, which respectively have red, green and blue filters Rf, Gf and Bf formed thereon. When transmittances of the red, green and blue filters Rf, Gf and Bf are increased, the selective transmission characteristics of the filters Rf, Gf and Bf with respect to the wavelength cannot be changed abruptly, resulting in a wide range of wavelengths of light transmitted through each of the filters Rf, Gf and Bf. Accordingly, wavelengths of transmitted light overlap widely between the red filter Rf and the green filter Gf and between the blue filter Bf and the green filter Gf.

As shown in FIG. 1(B), to increase the transmittances of the filters, for example, the blue filter Bf is designed as a high-pass filter for transmitting light at wavelengths of 400 nm to 550 nm therethrough, the red filter Rf is designed as a low-pass filter for transmitting light at wavelengths of 550 nm to 700 nm therethrough, and the green filter Gf is designed as a band-pass filter for transmitting light at wavelengths of 475 nm to 625 nm. As a result, the wavelengths to be transmitted overlap greatly between the green filter Gf and the blue filter Bf and between the green filter Gf and the red filter Rf.

The blue filter Bf and the red filter Rf are designed such that the transmittance decreases as the wavelength approximates 550 nm within a predetermined wavelength range centering around 550 nm, and the green filter Gf is designed such that the transmittance is constant within the predetermined wavelength range centering around 550 nm and decreases as the wavelength falls short of or goes beyond the predetermined range.

Note that, as shown in FIG. 1(C), the ranges of wavelengths of light transmitted through the red filter Rf and the blue filter Bf overlap at a wavelength of 550 nm, but the design is made to minimize the overlapping, i.e., to achieve a minimum possible width in view of manufacturability. The reason for this is to make light from the red backlight less transmittable through the blue filter Bf when the blue and red backlights are simultaneously turned on and also make light from the blue backlight less transmittable through the red filter Rf, thereby minimizing color purity reduction due to increased transmittances of the color filters.

In this manner, to increase the transmittances of the red, green and blue filters Rf, Gf and Bf, the design may be made such that wavelengths to be transmitted overlap greatly between the filters Rf and Gf and between the filters Gf and Bf, but in such a case, the color reproduction range decreases from 72% or higher to about 50% compared to display devices that display NTSC (National Television Standards Committee) images.

Accordingly, the time in which to turn on backlights, including CCFLs or LEDs (Light Emitting Diodes) with short persistence, is divided into a period in which to turn on a backlight which emits green light (hereinafter, referred to as a “green backlight”) and, a period in which to turn on both a backlight which emits red light (hereinafter, referred to as a “red backlight”) and a backlight which emits blue light (hereinafter, referred to as a “blue backlight”).

Specifically, in the first part of a frame period, a voltage to set the light transmittance at zero (hereinafter, referred to as a “zero-tone voltage”; in the case of a normally black-type liquid crystal, for example, 0V) is provided to both the red sub-pixel R and the blue sub-pixel B, and a signal voltage V_{g} is provided to the green sub-pixel G in accordance with a data signal D_{g} to be displayed. Then, thin film transistors (hereinafter, referred to as “TFTs”) provided in the red, blue and green sub-pixels R, B and G are turned off, leaving only the green backlight on.

In the second part of the frame period, the zero-tone voltage is provided to the green sub-pixel G and then the TFT in the green sub-pixel G is turned off at the same time as signal voltages V_{b} and Vᵣ are provided to the blue sub-pixel B and the red sub-pixel R, respectively, in accordance with data signals D_{b} and Dᵣ to be displayed. Then, the blue and red backlights are turned on.

Subsequently, the same operation is repeatedly performed to turn on only the green backlight in the first part of each frame period and then turn on the blue backlight and the red backlight in the second part. Since the blue and red backlights are off in the first part of a frame period, blue and red wavelength components respectively irradiated by the blue and red backlights are not transmitted through the green sub-pixel G. In addition, since the zero-tone voltage is provided to the red and blue sub-pixels R and B, light from the green backlight is not transmitted through the red and blue sub-pixels R and B. Consequently, among the color filters that transmit light at widely overlapping wavelengths, only the green filter Gf transmits light from the green CCFL. At this time, the blue and red wavelength components are also transmitted through the green filter Gf in an amount corresponding to an increase in the range of wavelengths transmitted through the green filter Gf, resulting in slightly reduced color purity.

Also, in the second part of the frame period, since the green backlight is off, the green wavelength component irradiated by the green backlight is not transmitted through the blue sub-pixel B and the red sub-pixel R. In addition, the zero-tone voltage is provided to the green sub-pixel G, and therefore light from the red and blue backlights is not transmitted through the green sub-pixel G. Consequently, among the color filters that transmit light at widely overlapping wavelengths, the red and blue filters Rf and Bf transmit light from the red and blue CCFLs, respectively. At this time, the green wavelength component is also transmitted through the red and blue filters Rf and Bf in an amount corresponding to an increase in the range of wavelengths transmitted through the red and blue filters Rf and Bf, resulting in slightly reduced color purity.

Briefly, in the first part of a frame period, the green backlight is turned on, with only the green sub-pixel G being allowed to transmit light therethrough. In the second part of the frame period, the blue and red backlights are turned on, with only the blue sub-pixel B and the red sub-pixel R being allowed to transmit light therethrough. By so controlling the backlights, it becomes possible to minimize color mixing caused when the transmittances are increased by widening the overlapping of wavelengths to be transmitted through the red, green and blue filters Rf, Gf and Bf. Thus, even when each sub-pixel has provided thereon red, green, blue filters Rf, Gf and Bf with increased transmittances, it is possible to manufacture a liquid crystal display device with a liquid crystal panel less susceptible to color purity reduction.

### 2. FIRST EMBODIMENT

### 2.1 Overall Configuration and Operation

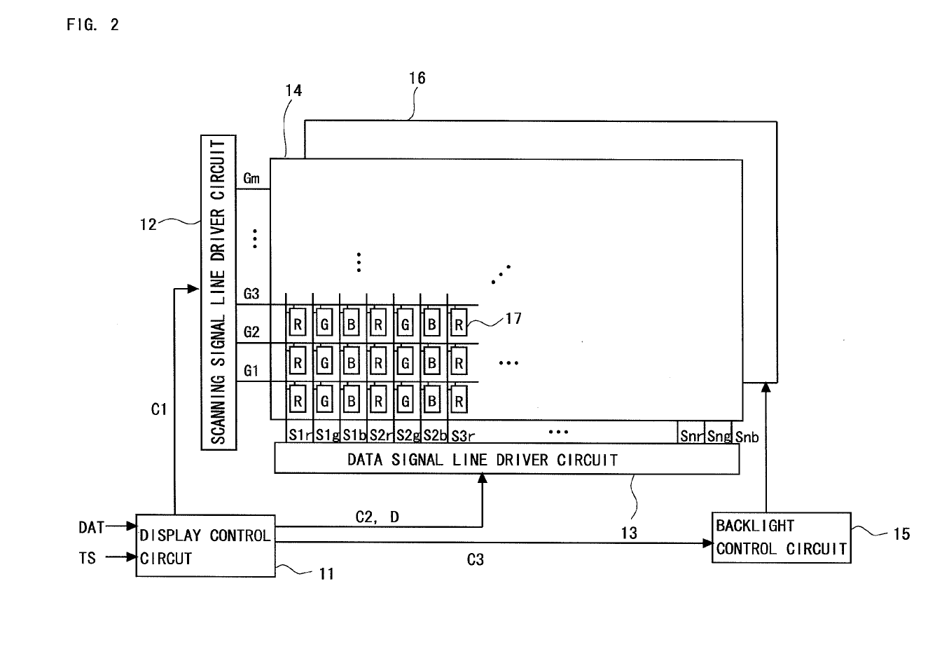

FIG. 2 is a block diagram illustrating the configuration of a liquid crystal display device according to a first embodiment of the present invention. The liquid crystal display device shown in FIG. 2 is an active-matrix liquid crystal display device including a display control circuit 11, a scanning signal line driver circuit 12, a data signal line driver circuit 13, a liquid crystal panel (display portion) 14, a backlight control circuit 15 and a backlight unit 16. Hereinafter, m and n are integers of 1 or more, i is an integer from 1 to m, and j is an integer from 1 to 3n.

The liquid crystal panel 14 has formed thereon (m×3n) display elements 17, m scanning signal lines G₁ to Gₘ, 3n data signal lines S₁ᵣ to Sₙᵣ, S_{1g} to S_{ng}, and S_{1b} to S_{nb}. The (m×3n) display elements 17 are equal in shape and size and they are arranged with 3n of them provided in the row direction (in FIG. 2, horizontally) and m of them provided in the column direction (in FIG. 2, vertically). The m scanning signal lines G₁ to Gₘ are arranged in parallel to each other, and the 3n data signal lines S₁ᵣ to Sₙᵣ, S_{1g} to S_{ng}, and S_{1b} to S_{nb} are arranged in parallel to each other in a direction perpendicular to the scanning signal lines G₁ to Gₘ. The 3n display elements 17 arranged in the same row are connected to any one of the m scanning signal lines G₁ to Gₘ. The in display elements 17 arranged in the same column are connected to any one of the 3n data signal lines S₁ᵣ to Sₙᵣ, S_{1g} to S_{ng}, and S_{1b} to S_{nb}.

The 3n display elements 17 successively arranged in the row direction within the liquid crystal panel 14 have formed thereon red, green and blue filters Rf, Gf and Bf respectively transmitting red, green and blue light therethrough. The n display elements 17 having the red filters Rf formed thereon function as red sub-pixels R, the n display elements 17 having the green filters Gf formed thereon function as green sub-pixels G, and the n display elements 17 having the blue filters Bf formed thereon function as blue sub-pixels B. Also, a single pixel is formed by a set of one red sub-pixel R, one green sub-pixel G, and one blue sub-pixel B.

The display control circuit 11 controls the operation of the liquid crystal display device based on an externally provided timing control signal TS, which includes horizontal/vertical synchronization signals, and also outputs a data signal D to the data signal line driver circuit 13 based on externally provided digital data DAT. More specifically, the display control circuit 11 outputs a control signal C₁ to the scanning signal line driver circuit 12, a control signal C₂ and the data signal D to the data signal line driver circuit 13, and a control signal C₃, which performs the on/off control of the backlights, to the backlight control circuit 15. The control signal C₁ includes a gate start pulse, a gate clock, and so on, while the control signal C₂ includes a source start pulse, a source clock, and so on.

The scanning signal line driver circuit 12 sequentially selects the in scanning signal lines one by one based on the control signal C₁, and applies voltage at a predetermined level to the selected scanning signal line. As a result, the selected scanning signal line is activated so that 3n sub-pixels (corresponding to n pixels) arranged in the same row are collectively selected from the display elements 17. When the scanning signal line is activated, all TFTs (not shown) in the 3n sub-pixels connected to the activated scanning signal line are turned on.

The data signal line driver circuit 13 stores 3n data signals D_{g}, Dᵣ and D_{b} based on the control signal C₂, and also applies n green signal voltages V_{g}, which correspond to the stored green data signals D_{g}, to n data signal lines S_{1g} to S_{ng} connected to the display elements 17 that function as the green sub-pixels G while simultaneously applying a zero-tone voltage to 2n data signal lines Sᵢᵣ to Sₙᵣ and S_{1b} to S_{nb} connected to the display elements 17 that function as either the red or blue sub-pixels R or B. Alternatively, 2n red and blue signal voltages Vᵣ and V_{b} corresponding to the stored red and blue data signals Dᵣ and D_{b} are respectively provided to 2n data signal lines S₁ᵣ to Sₙᵣ and S_{1b} to S_{nb} connected to the display elements 17 that function as either the red or blue sub-pixels R or B, and at the same time, a zero-tone voltage is provided to n data signal lines S_{1g} to S_{ng} connected to the display elements 17 that function as the green sub-pixels G. The signal voltages Vᵣ, V_{g} and V_{b} respectively provided to the data signal lines S₁ᵣ to Sₙᵣ, S_{1g} to S_{ng}, and S_{1b} to S_{nb} are in turn provided to 3n display elements 17 connected to the activated scanning signal line.

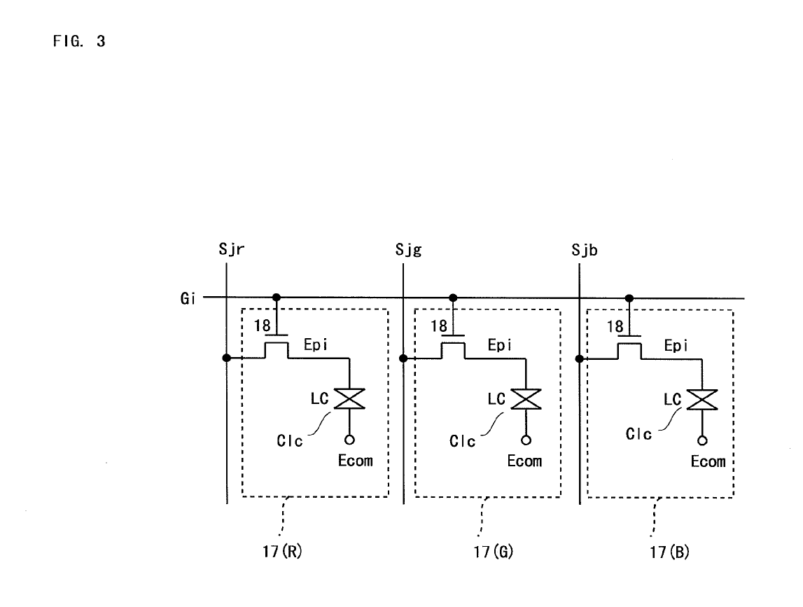

FIG. 3 is a diagram illustrating equivalent circuits of three display elements 17 respectively functioning as red, green and blue sub-pixels R, G and B. As shown in FIG. 3, each display element 17 includes a TFT 18 functioning as a switching element, a transparent pixel electrode Eₚᵢ provided on the liquid crystal panel 14, and a transparent common electrode E_{com} opposed to the pixel electrode Eₚᵢ, and the pixel electrode Eₚᵢ and the common electrode E_{com}, along with a liquid crystal LC provided therebetween, form a liquid crystal capacitance C_{1c}. The display element 17 is a hold-type display element for holding a signal voltage provided to the liquid crystal capacitance C_{1c} and transmitting light therethrough with a transmittance corresponding to the signal voltage being held. The equivalent circuits of the display elements 17 are equal in configuration and therefore only the display element 17 functioning as the red sub-pixel R will be described. The display element 17 has a gate terminal connected to the i'th scanning signal line Gᵢ, a source terminal connected to the j'th data signal line Sⱼᵣ, and a drain terminal connected to the pixel electrode Eₚᵢ. While the scanning signal line Gᵢ is active, the TFT 18 is turned on, so that the pixel electrode Eₚᵢ is connected to the data signal line Sⱼᵣ. Thereafter, while the scanning signal line Gᵢ is non-active, the signal voltage Vᵣ provided through the data signal line Sⱼᵣ is held in the liquid crystal capacitance C_{1c}. During this, the light transmittance of the display element 17 changes in accordance with the signal voltage Vᵣ being held in the liquid crystal capacitance C_{1c}. In this manner, the signal voltage Vᵣ corresponding to the data signal Dᵣ is provided to the liquid crystal capacitance C_{1c} in the display element 17, so that the display element 17 displays a desired image. The same applies to the display elements 17 functioning as either the green or blue sub-pixels G or B. Note that each of the display elements 17 in FIG. 3 may include an auxiliary capacitance. In such a case, the liquid crystal capacitance C_{1c} and the auxiliary capacitance form a pixel capacitance, and the signal voltage Vᵣ corresponding to the data signal Dᵣ is held in the pixel capacitance.

### 2.2 Configuration and Operation of the Backlight Unit

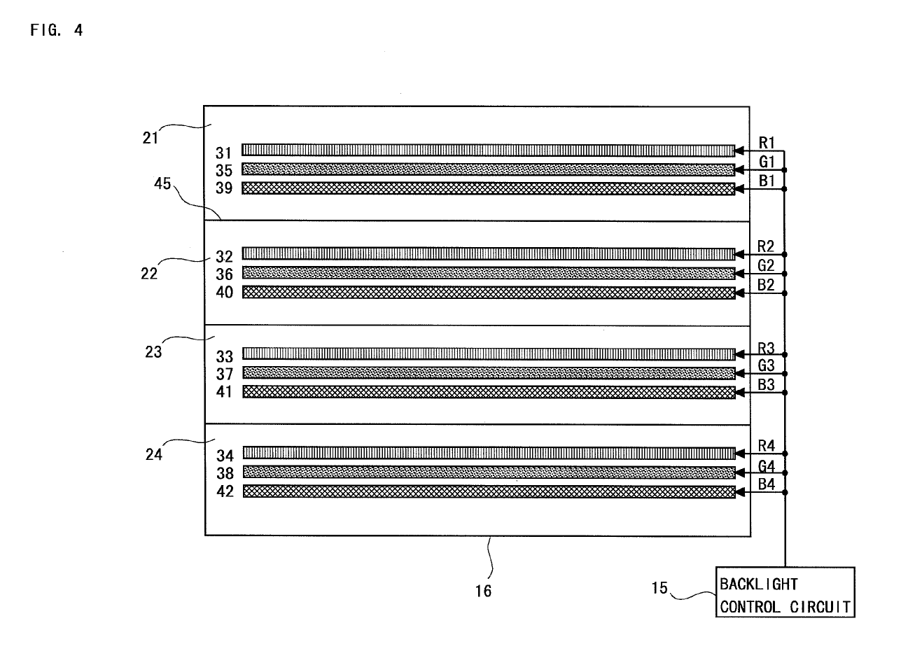

FIG. 4 is a diagram illustrating the configuration of the backlight unit 16 shown in FIG. 2. As shown in FIG. 4, the backlight unit 16 is perpendicularly (in FIG. 4, vertically) divided by partition plates 45 into four areas (hereinafter, such division areas are referred to as “blocks”). In the following descriptions, the blocks are referred to, in order from top, as a first block 21 to a fourth block 24.

Each of the four blocks 21 to 24 has a set of red, green and blue CCFLs attached thereto in a direction parallel to the scanning signal line (in FIG. 4, horizontally). Specifically, the liquid crystal panel 14 has attached to its back a total of 12 CCFLs, i.e., four red CCFLs 31 to 34, four green CCFLs 35 to 38, and four blue CCFLs 39 to 42. So, in the following descriptions, red, green and blue CCFLs attached to the k'th block (where (k is an integer from 1 to 4) are referred to as Rₖ-, Gₖ- and Bₖ-CCFLs, respectively.

For example, in the first block 21, when the G₁-CCFL 35 is turned on, the R₁-CCFL 31 and the B₁-CCFL 39 are turned off. Inversely, when the R₁-CCFL 31 and the B₁-CCFL 39 are turned on, the G₁-CCFL 35 is turned off. Furthermore, when the signal voltages Vᵣ, V_{g} and V_{b} are sequentially provided to the sub-pixels R, G and B in the first block 21, all CCFLs 31, 35 and 39 are turned off. Such on/off control of the CCFLs 31, 35 and 39 is performed by the backlight control circuit 15. The on/off control of the CCFLs is similarly performed in the second to fourth blocks 22 to 24 as well.

Adjacent blocks are partitioned with the partition plates 45 to prevent leakage of light from CCFLs attached in one block to another block, resulting in reduced display quality of the liquid crystal panel 14. By providing the partition plates 45, light from any CCFL that is on irradiates display elements in the block having the CCFL attached thereto and also irradiates display elements arranged close to the partition plate 45 in adjacent blocks, and therefore display elements in the blocks can be irradiated with light at uniform emission intensities.

The red and blue CCFLs are simultaneously turned on/off, and therefore instead of the red and blue CCFLs, a single CCFL in which red and blue fluorescent substances are enclosed.

### 2.3 Relationship Between the On/Off Timing and the Signal Voltage

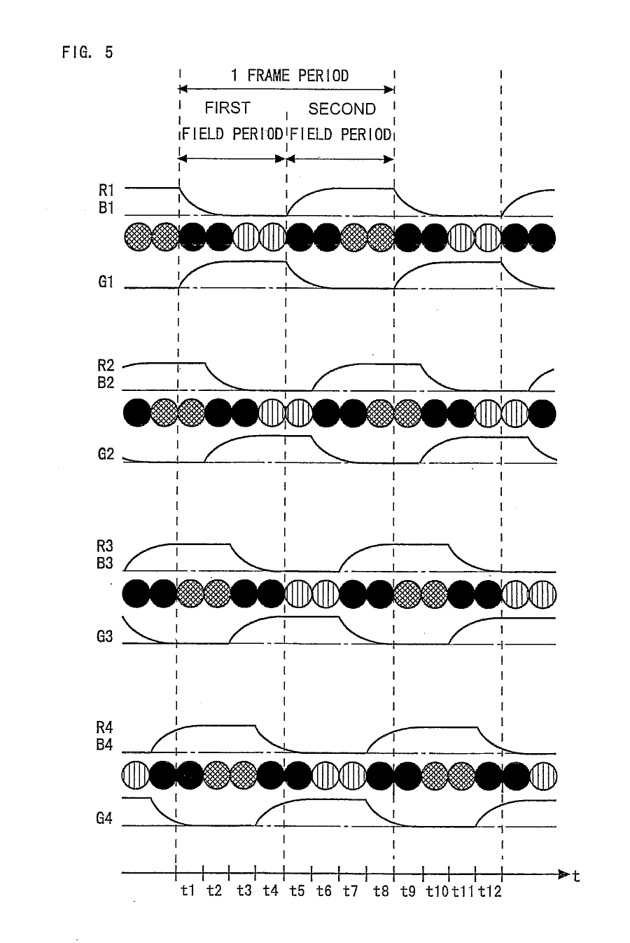

FIG. 5 is a timing chart for each of the blocks 21 to 24, from top, the first block 21, the second block 22, the third block 23, and the fourth block 24, illustrating the relationship between the on/off timing of the backlight unit 16 shown in FIG. 4 and the signal voltages Vᵣ, V_{g} and V_{b} respectively provided to the sub-pixels R, G and B.

As shown in FIG. 5, one frame period is made up of first and second field periods respectively including four periods t₁ to t₄ and four periods t₅ to t₈. Also, in FIG. 5, black circles denote that the red, green and blue CCFLs are all off, circles with vertical lines denote that the green CCFLs are off, and mesh circles denote that the red and blue CCFLs are on. Also, the solid lines above these circles denote transmittances of red sub-pixels R₁ to R₄ (R₁ to R₄ respectively represent the first- to fourth-block red sub-pixels; the same applies to the blue and green sub-pixels) and blue sub-pixels B₁ to B₄, which are respectively changed in accordance with signal voltages V₁ᵣ to V₄ᵣ (V₁ᵣ to V₄ᵣ represent signal voltages for first-to fourth-block red sub-pixels, respectively; the same applies to signal voltages for the blue and green sub-pixels) and V_{1b} to V_{4b}, which are respectively provided to the red sub-pixels R₁ to R₄ and the blue sub-pixels B₁ to B₄, and the solid lines below the circles denote transmittances of green sub-pixels G₁ to G₄, which are changed in accordance with signal voltages V_{1g} to V_{4g}, which are respectively provided to the green sub-pixels G₁ to G₄.

The first field period will now be described. In period t₁, the scanning signal lines in the first block 21 are sequentially activated, and TFTs of the sub-pixels R₁, G₁ and B₁ corresponding to the first block 21, which are connected to the same scanning signal line, are turned on, so that the signal voltage V_{1g} is provided to the green sub-pixel G₁ in accordance with a data signal D_{1g} to be displayed. Also, a zero-tone voltage is provided to the red and blue sub-pixels R₁ and B₁ connected to the same scanning signal line, and then the TFTs are turned off. After all the scanning signal lines in the first block 21 are activated, in period t₂, the operation is placed on hold until the liquid crystal responds to the provided signal voltage V_{1g}. Then, in periods t₃ and t₄, the G₁-CCFL 35 is turned on. At this time, since the R₁- and B₁-CCFLs 31 and 39 are off and the zero-tone voltage is provided to the red and blue sub-pixels R₁ and B₁, light from the G₁-CCFL 35 is transmitted through only the green sub-pixel G₁.

In period t₂, the scanning signal lines in the second block 22 are sequentially activated, and TFTs of the sub-pixels R₂, G₂ and B₂ corresponding to the second block 22, which are connected to the same scanning signal line, are turned on, so that the signal voltage V_{2g} is provided to the green sub-pixel G₂. Also, a zero-tone voltage is provided to the red and blue sub-pixels R₂ and B₂ connected to the same scanning signal line, and then the TFTs are turned off. After all the scanning signal lines in the second block 22 are activated, in period t₃, the operation is placed on hold until the liquid crystal responds to the provided signal voltage V_{2g}. Then, in periods t₄ and t₅, the G₂-CCFL 36 is turned on. At this time, since the R₂- and B₂-CCFLs 32 and 40 are off and the zero-tone voltage is provided to the red and blue sub-pixels R₂ and B₂, light from the G₂-CCFL 36 is transmitted through only the green sub-pixel G₂.

Subsequently, and similarly, as for the sub-pixels R₄, G₄ and B₄ corresponding to the fourth block 24, during the time from period t₄ to period t₇, the signal voltage V_{4g} is provided to the green sub-pixel G₄, and then the G₄-CCFL 38 is turned on. Consequently, light from the G₄-CCFL 38 is transmitted through only the green sub-pixel G₄.

Next, the second field period will be described. In period t₅, the scanning signal lines in the first block 21 are sequentially activated, and TFTs of the sub-pixels R₁, G₁ and B₁ corresponding to the first block 21, which are connected to the same scanning signal line, are turned on, so that the signal voltages V₁ᵣ and V_{1b} are provided to the red and blue sub-pixels R₁ and B₁, respectively, in accordance with data signals D₁ᵣ and D_{1b} to be displayed. Also, a zero-tone voltage is provided to the green sub-pixel G₁ connected to the same scanning signal line, and then the TFTs are turned off. After all the scanning signal lines in the first block 21 are activated, in period t₆, the operation is placed on hold until the liquid crystal responds to the provided signal voltages V₁ᵣ and V_{1b}. Then, in periods t₇ and t₈, the R₁- and B₁-CCFLs 31 and 39 are turned on. At this time, since the G₁-CCFL 35 is off and the zero-tone voltage is provided to the green sub-pixel G₁, light from the R₁-CCFL 31 and the B₁-CCFL 39 is transmitted through the red and blue sub-pixels R₁ and B₁, respectively.

The scanning signal lines in the second block 22 are sequentially activated, and in period t₆, TFTs of the sub-pixels R₂, G₂ and B₂ corresponding to the second block 22, which are connected to the same scanning signal line, are turned on, so that the signal voltages V₂ᵣ and V_{2b} are provided to the red and blue sub-pixels R₂ and B₂, respectively, in accordance with data signals D₂ᵣ and D_{2b} to be displayed. Also, a zero-tone voltage is provided to the green sub-pixel G₂ connected to the same scanning signal line, and then the TFTs are turned off. After all the scanning signal lines in the second block 22 are activated, in period t₇, the operation is placed on hold until the liquid crystal responds to the provided signal voltages V₂ᵣ and V_{2b}. Then, in periods t₈ and t₉ (i.e. , period t₁ of the next frame period), the R₂- and B₂-CCFLs 32 and 40 are turned on. At this time, since the G₂-CCFL 36 is off and the zero-tone voltage is provided to the green sub-pixel G₂, light from the R₂-CCFL 32 and the B₂-CCFL 40 is transmitted through the red and blue sub-pixels R₂ and B₂, respectively.

Subsequently, and similarly, as for the sub-pixels R₄, G₄ and B₄ corresponding to the fourth block 24, during the time from period t₈ to period t₁₁ (i.e., period t₃ of the next frame period), the signal voltages V₄ᵣ and V_{4b} are provided to the red and blue sub-pixel R₄ and B₄, respectively, and then R₄- and B₄-CCFLs 34 and 42 are turned on, so that light from the R₄-CCFL 34 and the B₄-CCFL 42 is transmitted through the red and blue sub-pixels R₄ and B₄, respectively.

When the transmittance of the green filter Gf is increased, the selective transmission characteristics of the filter do not change abruptly, resulting in a wide range of wavelengths of light transmitted through the green filter Gf and increased red and blue wavelength components included in light from the green CCFL. However, in the first field period, the red and blue CCFLs are off, and therefore no light from the red and blue CCFLs is transmitted through the green sub-pixel G. Thus, the amount of blue and red wavelength components transmitted through the green sub-pixel G can be suppressed. In addition, since the zero-tone voltage is provided to the red and blue sub-pixels R and B, light from the green CCFL is not transmitted through the red and blue sub-pixels R and B. Consequently, the liquid crystal panel 14 transmits therethrough light from the green CCFL, which is transmitted through the green sub-pixel G and has a wide wavelength range.

Similarly, when the transmittances of the red and blue filters Rf and Bf are increased, the selective transmission characteristics of the filters do not change abruptly, resulting in a wide range of wavelengths of light transmitted through each of the red and blue filters Rf and Bf and an increased green wavelength component included in light from the red and blue CCFLs. However, in the second field period, the green CCFL is off, and therefore no light from the green CCFL is transmitted through the red and blue sub-pixels R and B. Thus, the amount of green wavelength component transmitted through the red and blue sub-pixels R and B can be suppressed. In addition, since the zero-tone voltage is provided to the green sub-pixel G, light from the red and blue CCFLs is not transmitted through the green sub-pixel G. Consequently, the liquid crystal panel 14 transmits therethrough light from the red CCFL and the blue CCFL, which is transmitted through the red and blue sub-pixels R and B, respectively, and has a wide wavelength range.

### 2.4 Chromaticity Diagram

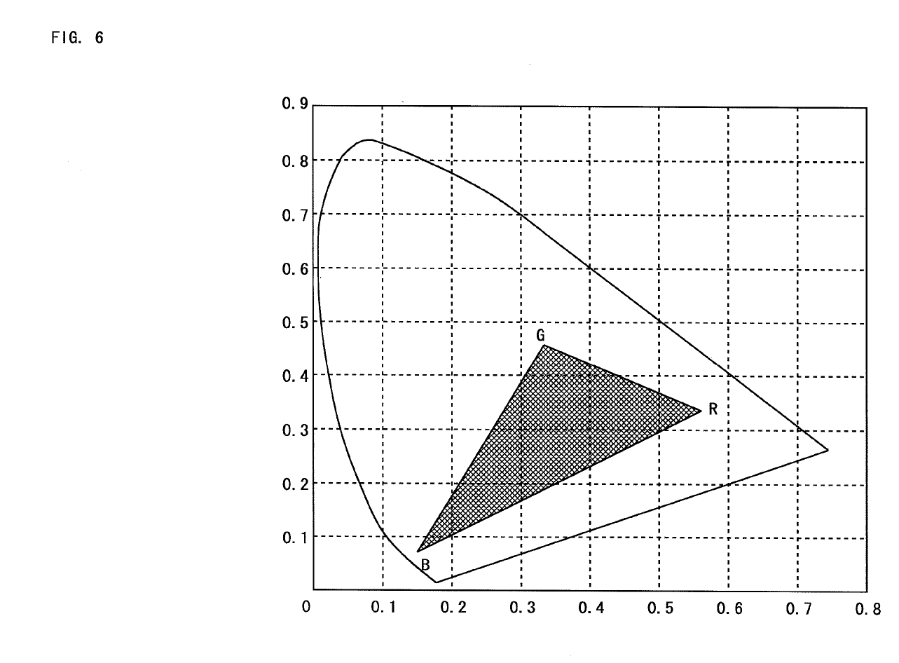

FIG. 6 is a chromaticity diagram for the XYZ color system. As is well known, the chromaticity diagram is obtained by the following equations. Where the wavelength is taken as λ, the light source spectral distribution is taken as P (λ), XYZ color-matching function values are taken as xb(λ) (where “b” denotes a “bar”, which refers to an average of x; the same applies to y and z), yb(λ), and zb(λ), and the value of transmittance characteristics of a transmittable object is taken as τ(80), X, Y and Z, three excitation purity values for the color of the transmittable object, are represented by the following equations (1) to (3), respectively. Note that K included in the following equations (1) to (3) is a constant.

[Eq. 1]

X=K∫₃₈₀⁷⁸⁰P(λ) x̅(λ)τ(λ)dλ (1)

[Eq. 2]

Y=K∫₃₈₀⁷⁸⁰P(λ) y̅(λ)τ(λ)dλ (2)

[Eq. 3]

Z=K∫₃₈₀⁷⁸⁰P(λ) z̅(λ)τ(λ)dλ (3)

X, Y and Z obtained by equations (1) to (3) are assigned to the following equations (4) to (6) to be converted into x, y and z.

[Eq. 4]

x=X/(X+Y+Z) (4)

[Eq. 5]

y=Y/(X+Y+Z) (5)

[Eq. 6]

z=Z/(X+Y+Z) (6)

Here, z in equation (6) can be obtained if x in equation (4) and y in equation (5) are known. Accordingly, the chromaticity diagram shown in FIG. 6 represents colors for the transmittable object as chromaticity coordinates (x,y) using x and y obtained by equations (4) and (5). All colors are represented by chromaticity coordinates within a hoof-like shape shown in FIG. 6, in which a reproducible color range of the transmittable object includes colors represented by chromaticity coordinates within a triangle rendered therein.

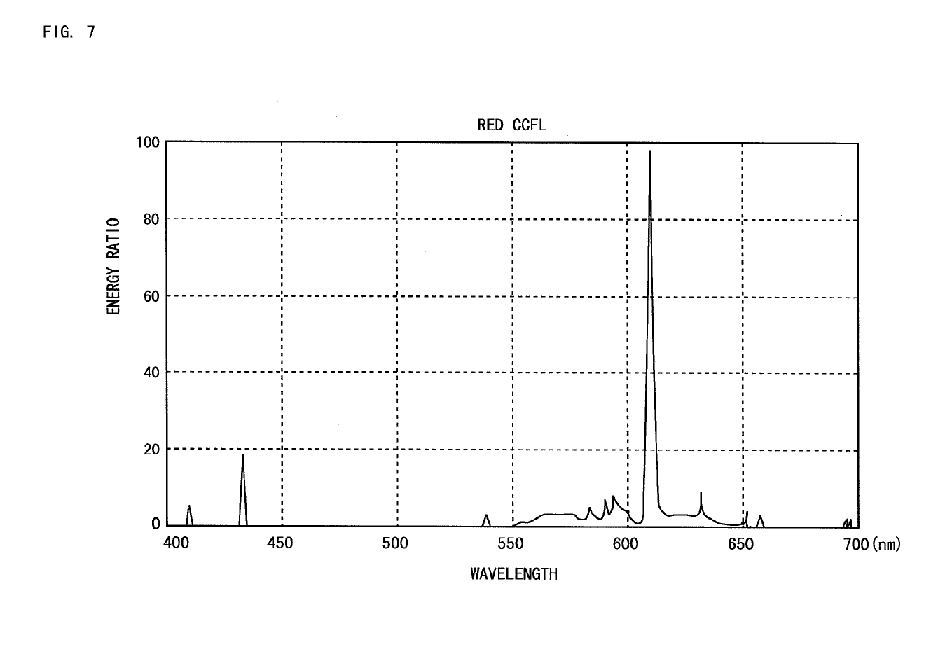

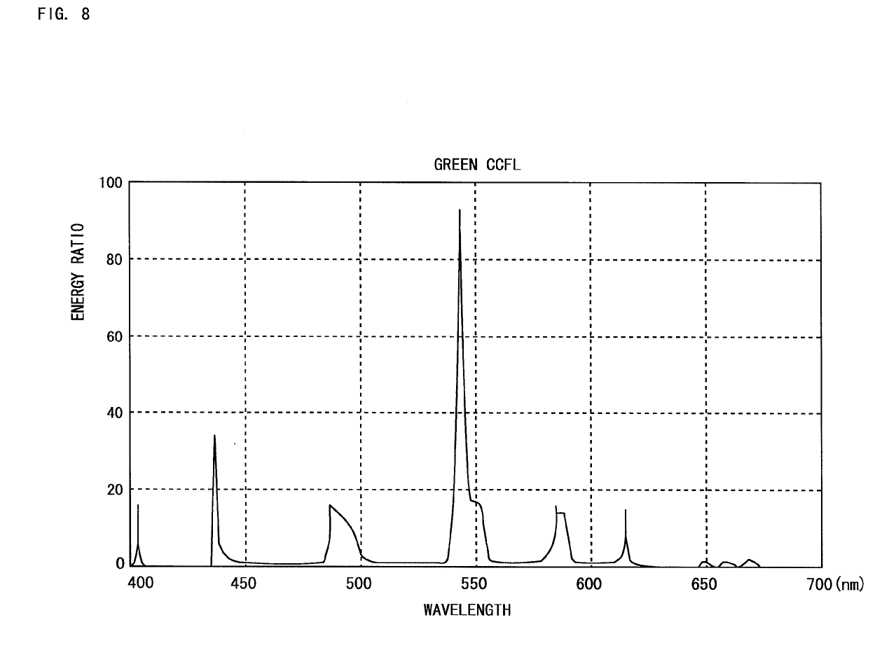

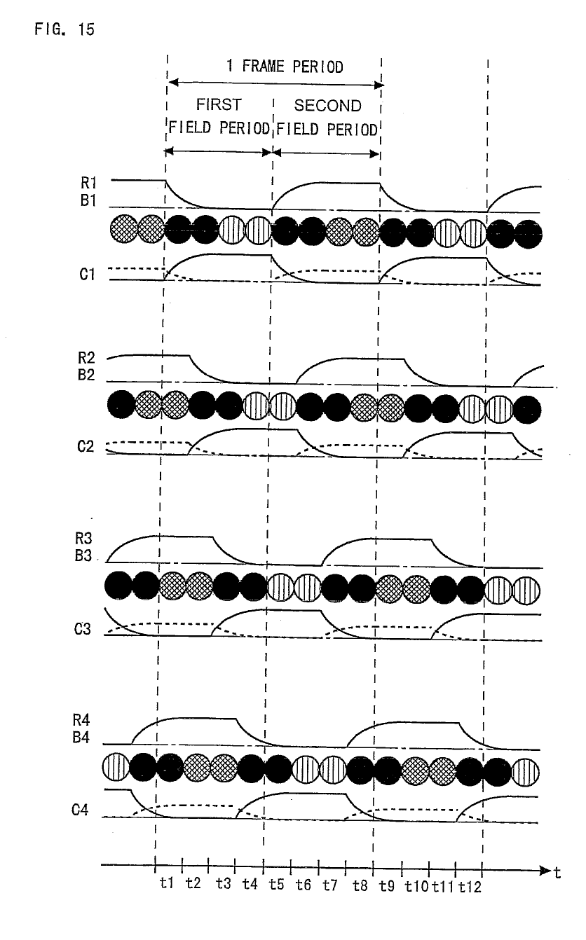

The spectral distribution P(λ) shown in FIGS. 7 to 9 respectively for the red, green and blue CCFLs is used as the spectral distribution P(λ) for equations (1) to (3), respectively. By obtaining chromaticity coordinates using the spectral distribution P(λ) for equations (1) to equation (5), it is possible to obtain a color reproduction range for a liquid crystal display using red, green and blue CCFLs as backlights. Note that FIG. 16 provides 3-band CCFL spectral distribution, where CCFLs with spectral distribution P(λ) shown in FIGS. 7 to 9 are turned on at the same time.

### 2.5 Effect

Conventionally, when the transmittances of the red, green and blue filters Rf, Gf and Bf are increased, selective transmission characteristics of the filters with respect to the wavelength cannot be changed abruptly, resulting in a wide range of wavelengths of light transmitted through the filters Rf, Gf and Bf. Therefore, when the red, green and blue CCFLs are simultaneously turned on, the green sub-pixel G transmits therethrough not only light from the green CCFL but also part of light from the red and blue CCFLs. At this time, green chromaticity coordinates move to the white color side (the center side of the triangle shown in FIG. 6). Similarly, the red and blue sub-pixels R and B have transmitted therethrough not only light from the red and blue CCFLs, respectively, but also part of light from the green CCFL, and therefore the red and blue chromaticity coordinates for the liquid crystal display shift to the green chromaticity coordinate side. Therefore, the area of the triangle shown in FIG. 6 is reduced, resulting in a narrow color reproduction range.

However, in the present embodiment, after the signal voltage Vg is provided to the green sub-pixel G, the green CCFL is turned on and the red and blue CCFLs are turned off. At this time, light transmitted through the green sub-pixel G includes red and blue wavelength components in an increased amount corresponding to an increased range of wavelengths transmitted through the green filter Gf, but does not include light from the red and blue CCFLs. Thus, it is possible to inhibit the green chromaticity coordinates from shifting to the white side.

Also, after the signal voltages Vᵣ and V_{b} are provided to the red and blue sub-pixels R and B, respectively, the red and blue CCFLs are turned on, and the green CCFL is turned off. At this time, light to be transmitted through the red and blue sub-pixels R and B includes a green wavelength component in an increased amount corresponding to an increased range of wavelengths to be transmitted through the red and blue filters Rf and Bf, but does not include light from the green CCFL. Thus, it is possible to inhibit the red and blue chromaticity coordinates from shifting to the green side. Note that as for the signal voltages Vᵣ and V_{b} provided to the red and blue sub-pixels R and B, it is preferable to create motion-interpolating images based on previous and subsequent frames. The method for creating such motion-interpolating images is made public as, for example, “61.2: A Development of Large-Screen full HD LCD TV with Frame-Rate-Conversion Technology” by SID (Society for Information Display) 2007, and therefore any detailed descriptions thereof are omitted herein.

As described above, in the liquid crystal display device of the present embodiment, even when the transmittances of the red, blue and green filters Rf, Gf and Bf are increased, it is possible to prevent the color reproduction range from being narrowed, i.e., it is possible to prevent color purity reduction. Also, by increasing the transmittances of the filters Rf, Gf and Bf, the light-emission intensities of the CCFLs can be reduced, thereby achieving low power consumption of the backlight unit 16.

### 2.6 Variants

In the first embodiment, the red, green and blue filters Rf, Gf and Bf are respectively formed on the surfaces of the red, green and blue sub-pixels R, G and B. Among these, even if only the green filter Gf on the green sub-pixel G is replaced with a colorless and transparent filter, it is possible to achieve almost the same effect as that can be achieved by the display device according to the first embodiment. In this case, it is possible to keep color filter production cost low compared to the case where the green filter Gf is formed.

However, as described above, the green filter Gf is designed as a band-pass filter which transmits therethrough light at wavelengths of from 475 nm to 625 nm. On the other hand, the spectral distribution of light emitted by the green CCFL includes wavelength components shorter than 475 nm and wavelength components longer than 625 nm, as shown in FIG. 8. Accordingly, the green sub-pixel G having the colorless and transparent filter formed thereon transmits the entire light from the green CCFL. Thus, when compared to the first embodiment, green displayed by the green sub-pixel G has a lower color purity.

### 3. SECOND EMBODIMENT

A liquid crystal display device according to a second embodiment is configured in the same manner as the display device according to the first embodiment, except that LEDs, in place of CCFLs, are used as backlights. Accordingly, any figure illustrating the configuration of the display device according to the second embodiment and any description thereof are omitted.

### 3.1 Configuration and Operation of the Backlight Unit

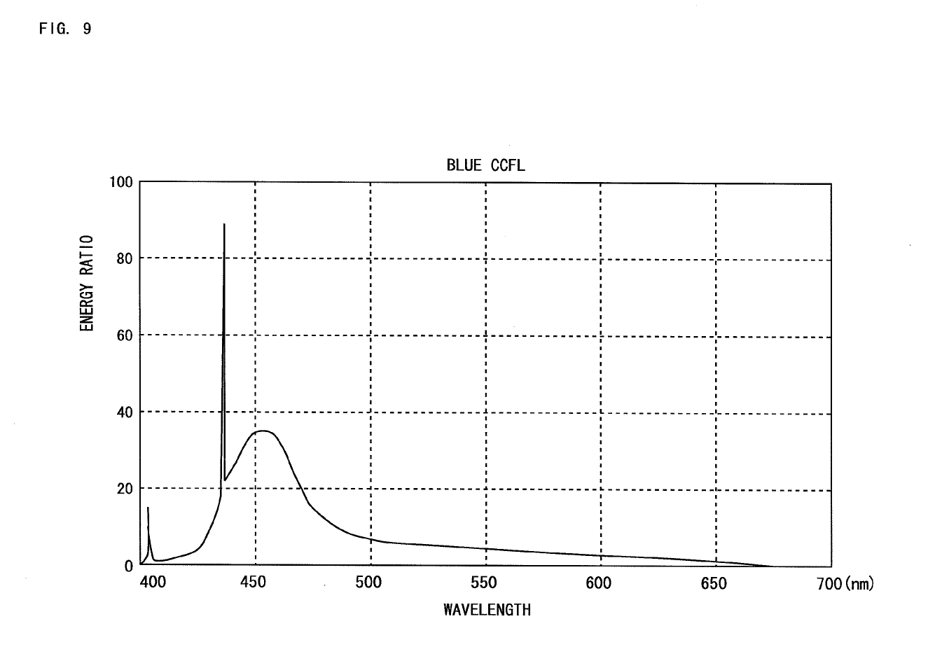

FIG. 10 is a diagram illustrating the configuration of a backlight unit 56 used in the liquid crystal display device according to the present embodiment. As shown in FIG. 10, the backlight unit 56 is perpendicularly (in FIG. 10, vertically) divided into four blocks 61 to 64 by partition plates 85. In the following descriptions, these blocks are referred to, from top, as first to fourth blocks 61 to 64.

Each of the blocks 61 to 64 has a plurality of LED light sources 60 arranged in a direction parallel to the scanning signal line (in FIG. 10, horizontally), each light source 60 including a red LED (hereinafter, referred to as an “R-LED 57”), a green LED (hereinafter, referred to as a “G-LED 58”) and a blue LED (hereinafter, referred to as a “B-LED 59”), which respectively emit red, green and blue light.

The LED light source 60 has the R- and B-LEDs 57 and 59 arranged in parallel to the scanning signal line and the G-LED 58 arranged to form an equilateral triangle together with the R- and B-LEDs 57 and 59 (delta arrangement). Also, adjacent LED light sources 60 are opposite in terms of the arrangement of the R-, B- and G-LED 57, 59 and 58 in the perpendicular direction. Therefore, the red, green and blue LEDs 57, 58 and 59 are uniformly arranged along the scanning signal line.

In the following descriptions, pluralities of R-, G- and B-LEDs arranged along the scanning signal line in the k'th block are referred to as Rₖ-, Gₖ- and Bₖ-LED lamps, respectively.

For example, in the first block 61, when the G₁-LED lamp 75 is turned on, the and R₁- and B₁-LED lamps 71 and 79 are turned off. Inversely, when the and R₁- and B₁-LED lamps 71 and 79 are turned on, the G₁-LED lamp 75 is turned off. Also, when the signal voltage V_{1g} is provided to the green sub-pixel G₁ in the first block 61 in accordance with the data signal D_{1g} or when the signal voltages V₁ᵣ and V_{1b} are provided to the red and blue sub-pixels R₁ and B₁, respectively, in accordance with the data signals D₁ᵣ and D_{1b}, all the LED lamps 71, 75 and 79 are turned off. Note that the on/off control of the LED lamps 71, 75 and 79 is performed by a backlight control circuit 55. The on/off control of the LED lamps is performed as well in the second to fourth blocks 62 to 64.

Adjacent blocks are partitioned by the partition plates 85 in order to prevent light from the LED lamps provided in one block from leaking into another block, resulting in reduced display quality of the liquid crystal panel 14. By providing the partition plates 85, light from any LED lamp that is on irradiates display elements in the block having that lamp provided therein and also irradiates display elements arranged close to the partition plate 85 in adjacent blocks, and therefore display elements in the blocks can be irradiated with light at uniform emission intensities.

Note that the arrangement of the LEDs 57, 58 and 59 in the LED light source 60 is not limited to the delta arrangement, and for example, the R-, G- and B-LEDs 57, 58 and 59 may be linearly arranged in order.

### 3.2 Relationship Between the On/Off Timing and the Signal Voltage

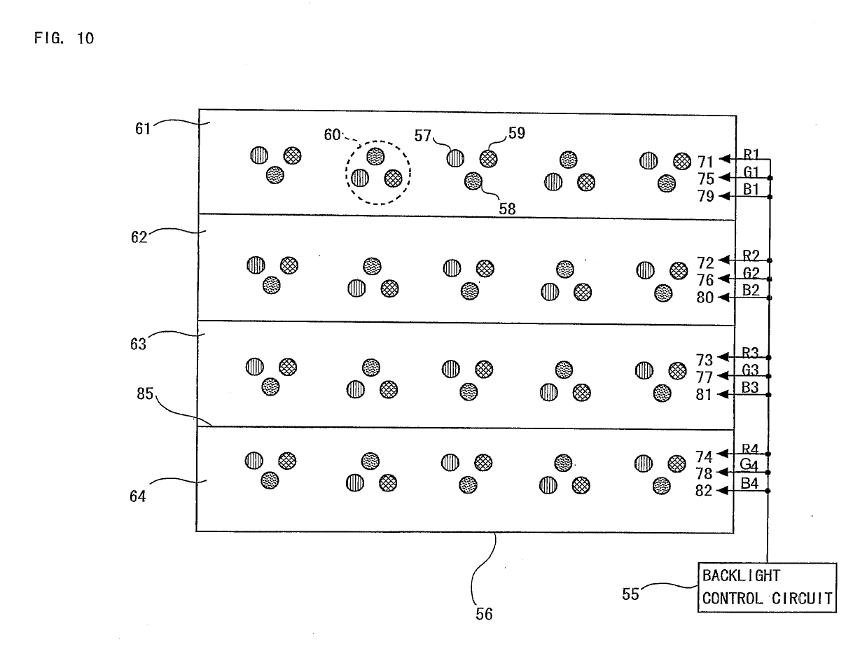

FIG. 11 is a timing chart for each of the blocks, from top, the first block 61, the second block 62, the third block 63, and the fourth block 64, illustrating the relationship between the on/off timing of the backlight unit 56 and the signal voltages Vᵣ, V_{g} and V_{b} respectively provided to the sub-pixels R, G and B.

As shown in FIG. 11, one frame period is made up of first and second field periods respectively including four periods t₁ to t₄ and four periods t₅ to t₈. Also, in FIG. 11, black circles, circles with vertical lines, mesh circles, and solid lines above and below the circles denote the same as in FIG. 5, and therefore any descriptions thereof are omitted. Dotted lines indicated above the circles denote the transmittances of the red and blue sub-pixels R₁ to R₄ and B₁ to B₄, which are changed in accordance with signal voltages provided to the red and blue sub-pixels R₁ to R₄ and B₁ to B₄ and constituting part of the signal voltages V_{1g} to V_{4g} that should be originally provided to the green sub-pixels G₁ to G₄.

The first field period will now be described. In period t₁, the scanning signal lines in the first block 61 are sequentially activated, and TFTs of the sub-pixels R₁, G₁ and B₁ corresponding to the first block 61, which are connected to the same scanning signal line, are turned on, so that a signal voltage V_{1g}, is provided to the green sub-pixel G₁ in accordance with a part D_{1g}, of the data signal D_{1g} that should be originally displayed. Also, a signal voltage (V_{1g}-V_{1g′}), which corresponds to the rest (V_{1g}-V_{1g′}) of the data signal D_{1g} that should be originally displayed by the sub-pixel G₁, is provided to the red and blue sub-pixels R₁ and B₁ connected to the same scanning signal line. After all the scanning signal lines in the first block 61 are activated, in period t₂, the operation is placed on hold until the liquid crystal responds to the provided signal voltages V_{1g′}, and (V_{1g}-V_{1g′}) provided to the sub-pixels R₁, G₁ and B₁. Then, in periods t₃ and t₄, the G₁-LED lamp 75 is turned on. At this time, since the and R₁-B₁-LED lamps 71 and 79 are off, light from the G₁-LED lamp 75 is transmitted through not only the green filter Gf but also the red and blue filters Rf and Bf.

In period t₂, the scanning signal lines in the second block 62 are sequentially activated, and TFTs of the sub-pixels R₂, G₂ and B₂ corresponding to the second block 62, which are connected to the same scanning signal line, are turned on, so that a signal voltage V_{2g′} is provided to the green sub-pixel G₂ in accordance with a part D_{2g′} of the data signal D_{2g} that should be originally displayed. Also, a signal voltage (V_{2g}-V_{2g′}), which corresponds to the rest (D_{2g}-D_{2g′}) of the data signal D_{2g} that should be originally displayed by the sub-pixel G₂, is provided to the red and blue sub-pixels R₂ and B₂ connected to the same scanning signal line. After all the scanning signal lines in the second block 62 are activated, in period t₃, the operation is placed on hold until the liquid crystal responds to the provided signal voltages V_{2g′}, and (V_{2g}-V_{2g′}) provided to the sub-pixels R₂, G₂ and B₂. Then, in periods t₄ and t₅, the G₂-LED lamp 76 is turned on. At this time, since the R₂- and B₂-LED lamps 72 and 80 are off, light from the G₂-LED lamp 76 is transmitted through not only the green sub-pixel G₂ but also the red and blue sub-pixels R₂ and B₂.

Subsequently, and similarly, as for the sub-pixels R₄, G₄ and B₄ corresponding to the fourth block 64, during the time from period t₄ to period t₇, a signal voltage V_{4g′} is provided to the green sub-pixel G₄ in accordance with a part D_{4g′} of the data signal D_{4g} that should be originally displayed, and a signal voltage (V_{4g}-V_{4g′}) which corresponds to the rest (D_{4g}-D_{4g′}) of the data signal D_{4g} that should be originally displayed by the sub-pixel G₄, is provided to the red and blue sub-pixels R₄ and B₄. Then, the G₄-LED lamp 78 is turned on, so that light from the G₄-LED lamp 78 is transmitted through not only the green sub-pixel G₄ but also the red and blue sub-pixels R₄ and B₄.

Note that the relationship between the on/off timing of the LED lamps in the blocks 61 to 64 and the signal voltages provided to the sub-pixels in the second field period is the same as in the second field period shown in FIG. 5 for the first embodiment, and therefore any descriptions thereof are omitted.

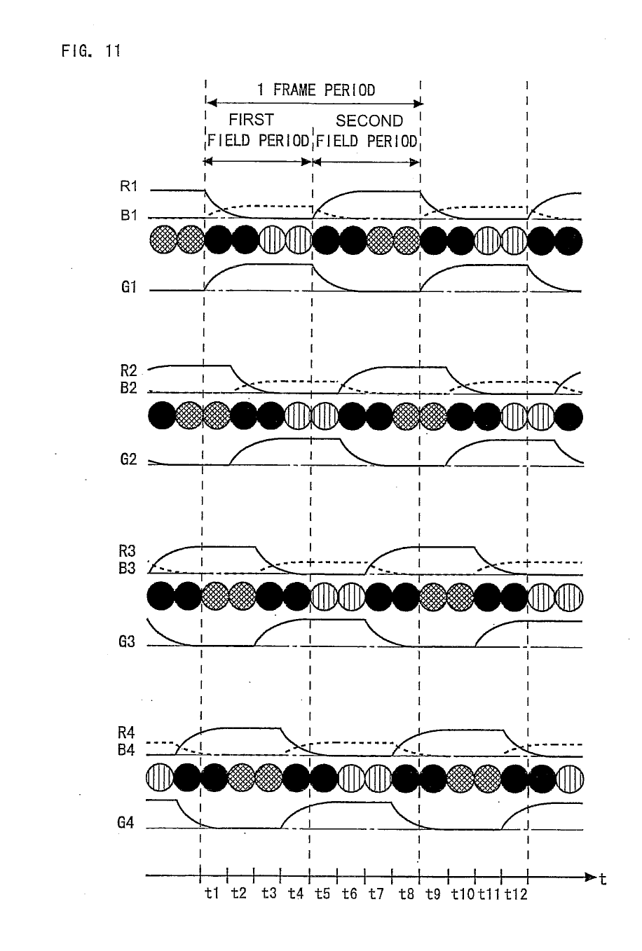

FIG. 12 is a graph illustrating the relationship between the wavelength and the emission intensity of light emitted by the red, green and blue LEDs included in the LED light source 60. As shown in FIG. 12, light emitted by the green LED includes very few wavelength components included in light emitted by the red and blue LEDs. Therefore, by providing the red and blue sub-pixels R and B with a part of the signal voltage V_{g} in accordance with the data signal D_{g} that should be originally displayed by the green sub-pixel G, as described above, it is possible to suppress color purity reduction due to the green LED being turned on.

Also, the signal voltage (V_{g}-V_{g′}) provided to the red and blue sub-pixels R and B, which constitutes a part of the signal voltage V_{g} in accordance with the data signal D_{g} that should be originally displayed by the green sub-pixel G, is preferably lower than the signal voltage V_{g′} provided to the green sub-pixel G. In this case, it is made possible that fewer of the red and blue wavelength components included in light from the green LED lamp is transmitted through the red and blue filters Rf and Bf, respectively, and therefore color purity reduction can be suppressed.

Also, in the first field period, the signal voltage (V_{g}-V_{g′}) in accordance with the rest (V_{g}-V_{g′}) of the data signal D_{g} that should be originally displayed by the green sub-pixel G is provided to both the red and blue sub-pixels R and B, but it may be provided to one of the sub-pixels.

Also, the backlight unit 56 can be controlled in the same manner as the backlight unit 16 in the first embodiment, but wavelength dispersion of the LED is lower than that of the CCFL, and therefore the color reproduction range of the LED is originally wide. Thus, only a small effect can be achieved by turning on/off the backlight unit 56 in the same manner as the backlight unit 16.

### 3.3 Effect

As described above, when the green LED lamp is on, the red and blue LED lamps are off, and when the green LED lamp is off, the red and blue LED lamps are on, which makes it possible to prevent color purity reduction.

Also, the rest (V_{g}-V_{g′}) of the signal voltage V_{g} that should be originally provided to the green sub-pixel G is provided to the red and blue sub-pixels R and B, so that light from the green LED lamp is transmitted through not only the green sub-pixel G but also the red and blue sub-pixels R and B. In this manner, by effectively utilizing light from the green LED lamp, it becomes possible to increase light-use efficiency. Consequently, even if the emission intensity of the green LED lamp is reduced, the luminance of the liquid crystal panel can be kept high, making it possible to achieve low power consumption of the backlight unit 56.

### 3.4 First Variant

In the second embodiment, the signal voltage V_{g′} is provided to the green sub-pixel G in accordance with a part D_{g′}of the data signal D_{g} that should be originally displayed by the green sub-pixel G and the signal voltage (V_{g}-V_{g′}) is provided to the red and blue sub-pixels R and B in accordance with the rest (D_{g}-D_{g′}) of the data signal D_{g}, so that the green LED lamp can be more efficiently used, but light from the green LED lamp is also transmitted through the red and blue filters Rf and Bf, resulting in a narrower color reproduction range.

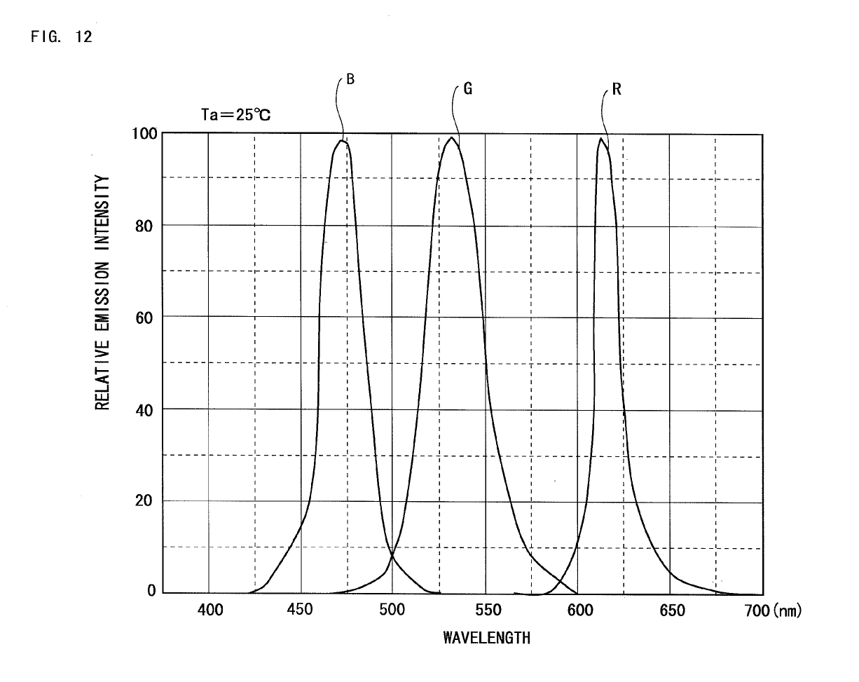

Therefore, in the case where light has an almost white color with chromaticity coordinates between blue and green in area “a” within the color reproduction range of the liquid crystal display in a chromaticity diagram shown in FIG. 13, the signal voltage (V_{g}-V_{g′}) in accordance with the rest (D_{g}-D_{g′}) of the data signal D_{g} that should be originally displayed by the green sub-pixel G is provided to the blue sub-pixel B but is not provided to the red sub-pixel R.

On the other hand, in the case where light has an almost white color with chromaticity coordinates between red and green in area “b”, the signal voltage (V_{g}-V_{g′}) in accordance with the rest (D_{g}-D_{g′}) of the data signal D_{g} that should be originally displayed by the green sub-pixel G is provided to the red sub-pixel R but is not provided to the blue sub-pixel B.

Note that in either case, as for light having an almost white color with chromaticity coordinates between red and green in area “c”, it is conceivable that the problem with a narrower color reproduction range hardly occurs. Therefore, the signal voltage (V_{g}-V_{g′}) in accordance with the rest (D_{g}-D_{g′}) of the data signal D_{g} that should be originally displayed by the green sub-pixel G may be provided to either the red sub-pixel R or the blue sub-pixel B or to both the red sub-pixel R and the blue sub-pixel B.

In this manner, in the case where the color reproduction range is narrowed, the method as described above is used for any color with chromaticity coordinates within area “a”, “b” or “c” shown in FIG. 13, thereby allowing the green LED lamp to be used more efficiently without narrowing the color reproduction range.

### 3.5 Second Variant

In the second embodiment and the first variant thereof, the red, green and blue filters Rf, Gf and Bf are respectively formed on the surfaces of the red, green and blue sub-pixels R, G and B. Among these, even if only the green filter Gf on the green sub-pixel G is replaced with a colorless and transparent filter, it is possible to achieve almost the same effect as that can be achieved by the display devices according to the second embodiment and the first variant thereof. In this case, it is possible to keep color filter production cost low compared to the case where the green filter Gf is formed.

Note that, unlike in the variant of the first embodiment, wavelength dispersion of the LED is lower than that of the CCFL. Therefore, in the case of this liquid crystal display device, formation of no green filter Gf has little adverse impact, and it is possible to achieve approximately the same effect as that achieved by the display device according to the second embodiment.

### 4. THIRD EMBODIMENT

A liquid crystal display device according to a third embodiment is configured in the same manner as the display device according to the first embodiment, except that LEDs, in place of the CCFLs, are used as backlights, and cyan filters Cf are substituted for the green filters Gf which, along with the red and blue filters Rf and Bf, are formed on the display elements. Also, the backlight unit is configured in the same manner as the backlight unit 56 used in the liquid crystal display device according to the second embodiment. Therefore, any diagrams and descriptions illustrating the configurations of the liquid crystal display device according to the third embodiment and the backlight unit thereof are omitted.

### 4.1 Filter Arrangement

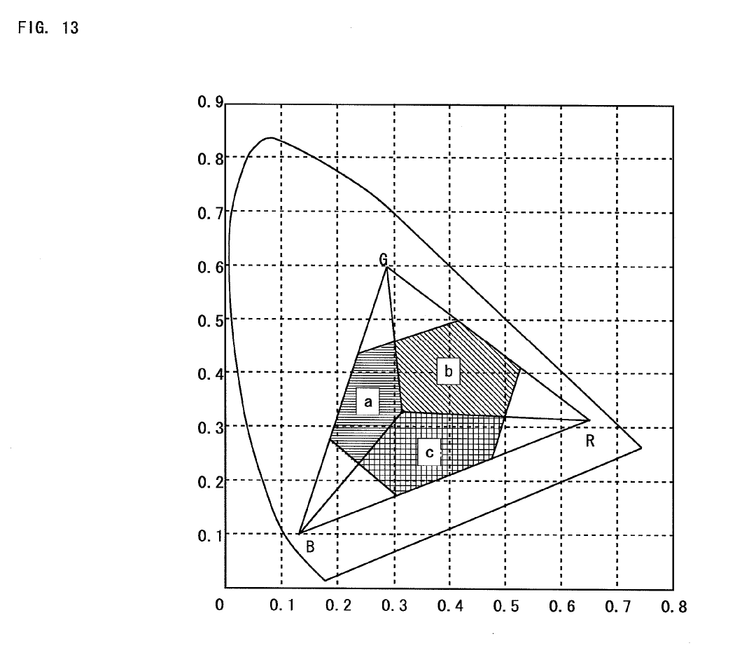

FIG. 14 provides diagrams for the liquid crystal display device according to the third embodiment, illustrating (A) an arrangement of the filters Rf, Cf and Bf respectively formed on the red, cyan and blue sub-pixels R, C and B, (B) the relationship between the transmittance and the wavelength for the filters Rf, Cf and Bf, and (c) the relationship between the transmittance and the wavelength for the filters Rf, Cf and Bf shown in (B) where they are placed on one another.

As shown in FIG. 14(A), the color filters are arranged such that the blue, cyan and red filters Rf, Cf and Bf are sequentially disposed one by one in the row direction (in FIG. 14(A), horizontally). Also, as shown in FIG. 14(B), wavelengths of light transmitted through the blue and red filters Bf and Rf are the same as those for the blue and red filters Bf and Rf shown in FIG. 1(B). The cyan filters Cf are formed in place of the green filters Gf in FIG. 1(B) and have a combination of the functions of both the blue and green filters Bf and Gf to transmit light at wavelengths of from 400 nm to 625 nm.

### 4.2 Relationship Between the On/Off Timing and the Signal Voltage

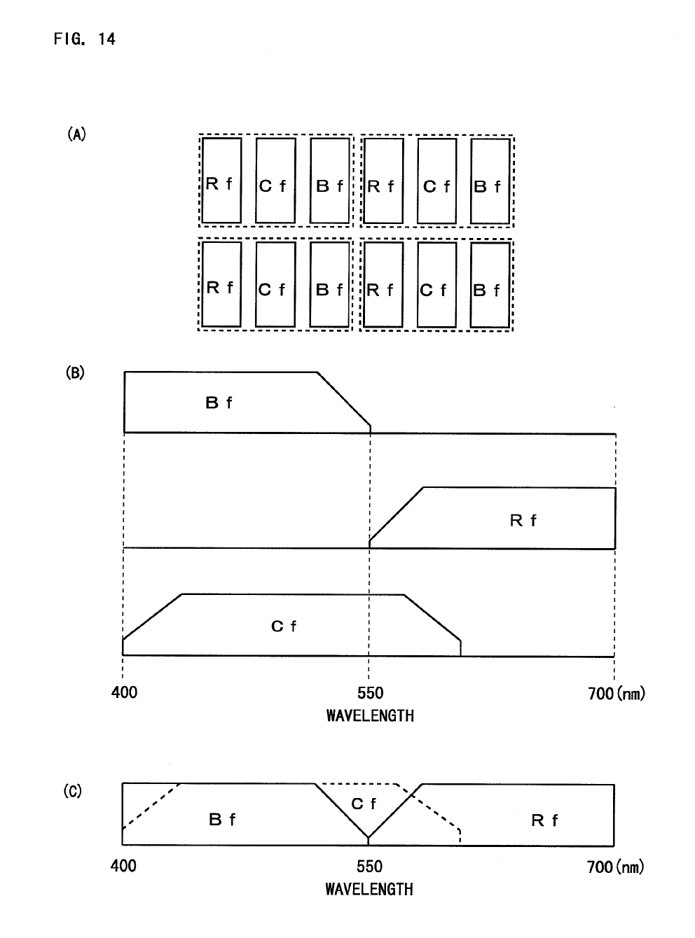

FIG. 15 is a timing chart for each of the blocks 61 to 64, from top, the first block 61, the second block 62, the third block 63, and the fourth block 64, illustrating the relationship between the on/off timing of the backlight unit 56 and the signal voltages Vᵣ, V_{c} and V_{b} respectively provided to the sub-pixels R, C and B.

As shown in FIG. 15, one frame period is made up of first and second field periods respectively including four periods t₁ to t₄ and four periods t₅ to t₈. Also, in FIG. 15, black circles, circles with vertical lines, mesh circles, and solid lines above and below the circles denote the same as in FIG. 5, and therefore any descriptions thereof are omitted. Also, dotted lines indicated below the circles denote the transmittances of the cyan sub-pixels C₁ to C₄, which are changed in accordance with signal voltages provided to the cyan sub-pixels C₁ to C₄ and constituting part of the signal voltage V_{b} that should be originally provided to the blue sub-pixels B₁ to B₄.

The first field period will now be described. In period t₁, the scanning signal lines in the first block 61 are sequentially activated, and TFTs of the sub-pixels R₁, C₁ and B₁ corresponding to the first block 61, which are connected to the same scanning signal line, are turned on, so that a signal voltage V_{1c} is provided to the cyan sub-pixel C₁ in accordance with a data signal D_{1c}. Also, a zero-tone voltage is provided to the red and blue sub-pixels R₁ and B₁ connected to the same scanning signal line, and then the TFTs are turned off. After all the scanning signal lines in the first block 61 are activated, in period t₂, the operation is placed on hold until the liquid crystal responds to the signal voltage V_{1c} provided to the cyan sub-pixel C₁. Then, in periods t₃ and t₄, the G₁-LED lamp 75 is turned on. At this time, since the R₁- and B₁-LED lamps 71 and 79 are off and the zero-tone voltage is provided to the red and blue sub-pixels R₁ and B₁, light from the G₁-LED lamp 75 is transmitted through only the cyan sub-pixel C₁.

In period t₂, the scanning signal lines in the second block 62 are sequentially activated, and TFTs of the sub-pixels R₂, C₂ and B₂ corresponding to the second block 62, which are connected to the same scanning signal line, are turned on, so that a signal voltage V_{2c} is provided to the cyan sub-pixel C₂. Also, a zero-tone voltage is provided to the red and blue sub-pixels R₂ and B₂ connected to the same scanning signal line, and then the TFTs are turned off. After all the scanning signal lines in the second block 62 are activated, in period t₃, the operation is placed on hold until the liquid crystal responds to the signal voltage V_{2c}provided to the cyan sub-pixel C₂. Then, in periods t₄ and t₅, the G₂-LED lamp 76 is turned on. At this time, since the R₂- and B₂-LED lamps 72 and 80 are off and the zero-tone voltage is provided to the red and blue sub-pixels R₂ and B₂, light from the G₂-LED lamp 76 is transmitted through only the cyan sub-pixel C₂.

Subsequently, and similarly, as for the sub-pixels R₄, C₄ and B₄ corresponding to the fourth block 64, during the time from period t₄ to period t₇, a signal voltage V_{4c} is provided to the cyan sub-pixel C₄, and the G₄-LED lamp 78 is turned on. At this time, light from the G₄-LED lamp 78 is transmitted through only the cyan sub-pixel C₄.

Next, the second field period will be described. In period t₅, the scanning signal lines in the first block 61 are sequentially activated, and TFTs of the sub-pixels R₁, C₁ and B₁ corresponding to the first block 61, which are connected to the same scanning signal line, are turned on, so that signal voltages V_{1r and V}_{1b′} are provided to the red and blue sub-pixels R₁ and B₁ in accordance with the data signal D₁ᵣ that should be originally displayed by the red sub-pixel R₁ and a part D_{1b′}of the data signal D_{1b} that should be originally displayed by the blue sub-pixel B₁. Also, a signal voltage (V_{1b}-V_{1b′}), which corresponds to the rest (D_{1b}-D_{1b′}) of the data signal D_{1b} that should be originally displayed by the blue sub-pixel B₁, is provided to the cyan sub-pixel C₁ connected to the same scanning signal line. After all the scanning signal lines in the first block 61 are activated, in period t₆, the operation is placed on hold until the liquid crystal responds to the provided signal voltages V₁ᵣ, and V_{1b′}, and (V_{1b}-V_{1b′}). Then, in periods t₇ and t₈, the R₁- and B₁-LED lamps 71 and 79 are turned on. At this time, the G₁-LED lamp 75 is off. Therefore, light from the R₁- and B₁-LED lamps 71 and 79 is transmitted through the red sub-pixel C₁ and the blue sub-pixel B₁, respectively, and the light from the B₁-LED lamp 79 is also transmitted through the cyan sub-pixel C₁.

In period t₆, the scanning signal lines in the second block 62 are sequentially activated, and TFTs of the sub-pixels R₂, C₂ and B₂ corresponding to the second block 62, which are connected to the same scanning signal line, are turned on, so that signal voltages V₂ᵣ and V_{2b′} are provided to the red and blue sub-pixels R₂ and B₂, respectively, in accordance with the data signal D₂ᵣ that should be originally displayed by the red sub-pixel and a part D_{2b′} of the data signal D_{2b} that should be originally displayed by the blue sub-pixel B₂. Also, a signal voltage (V_{2b}-V_{2b′}) in accordance with the rest (D_{2b}-D_{2b′}) of the data signal D_{2b} that should be originally displayed by the blue sub-pixel B₂ is provided to the cyan sub-pixel C₂ connected to the same scanning signal line. After all the scanning signal lines in the second block 62 are activated, in period t₇, the operation is placed on hold until the liquid crystal responds to the provided signal Voltages V₂ᵣ, V_{2b′} and (V_{2b}-V_{2b′}). Then, in periods t₈ and t₉ (i.e., period t₁ of the next frame period), the R₂- and B₂-LED lamps 72 and 80 are turned on. At this time, the G₂-LED lamp 76 is off. Therefore, light from the R₂- and B₂-LED lamps 72 and 80 is transmitted through the red and blue sub-pixels R₂ and B₂, respectively, and the light from the B₂-LED lamp 80 is also transmitted through the cyan sub-pixel C₂.

Subsequently, and similarly, as for the sub-pixels R₄ᵣ, C₄ and B₄ corresponding to the fourth block 64, during the time from period t₈ to period t₁₁ (i.e., period t₃ of the next frame period), signal voltages V₄ᵣ and V_{4b′} are provided to the red and blue sub-pixel R₄ and B₄, respectively, in accordance with the data signal D₄ᵣ that should be originally displayed by the red sub-pixel and a part D_{4b′} of the data signal D_{4b} that should be originally displayed by the blue sub-pixel B₄. Also, a signal voltage (V_{4b}-V_{4b′}) is provided to the cyan sub-pixel C₄ in accordance with the rest (D_{4b}-D_{4b′}) of the data signal D_{4b} that should be originally displayed by the blue sub-pixel B₄. Then, R₄- and B₄-LED lamps 74 and 82 are turned on. Consequently, light from the R₄ and B₄-LED lamps 74 and 82 is transmitted through the red and blue sub-pixels R₄ and B₄, and the light from the B₄-LED lamp 82 is also transmitted through the cyan sub-pixel C₄.

In this manner, in the first field period, since only the green LED lamp is turned on and the zero-tone voltage is provided to the red and blue sub-pixels R and B, the cyan sub-pixel C transmits therethrough light from the green LED lamp.

Also, in the second field period, the red and blue sub-pixels R and B have transmitted therethrough light from the R- and B-LED lamps, respectively. Furthermore, since the signal voltage (V_{b}-V_{b′}) is provided to the cyan sub-pixel C in accordance with the rest (D_{b}-D_{b′}) of the data signal D_{b} that should be originally displayed by the blue sub-pixel B, the cyan sub-pixel C also transmits therethrough light from the blue LED lamp.

Note that the signal voltage (V_{b}-V_{b′}) provided to the cyan sub-pixel C, which is included in the signal voltage V_{b} in accordance with the data signal D_{b} that should be originally displayed by the blue sub-pixel B, is preferably lower than the signal voltage V_{b} provided to the blue sub-pixel B. In this case, it is rendered possible to allow the cyan sub-pixel C to transmit therethrough fewer of the green wavelength component included in the light from the blue LED lamp, and therefore color purity reduction can be suppressed.

Also, the backlight unit 56 can be controlled in the same manner as the backlight unit 16 in the first embodiment, but the LED wavelength dispersion is lower than the CCFL wavelength dispersion, and therefore the LED color reproduction range is naturally wide. Thus, only a slight effect can be achieved by turning on/off the backlight unit 56 in the same manner as the backlight unit 16.

### 4.3 Effect

As described above, when the green LED lamp is on, the red and blue LED lamps are off, and when the green LED lamp is off, the red and blue LED lamps are on, which makes it possible to prevent color purity reduction.

Also, when turning on the red and blue LED lamps, if the rest (V_{b}-V_{b′}) of the signal voltage V_{b} that should be originally provided to the blue sub-pixel B is provided to the cyan sub-pixel C, light from the blue LED lamp is transmitted through not only the blue sub-pixel B but also the cyan sub-pixel C. In this manner, by effectively utilizing light from the blue LED lamp, it becomes possible to increase its use efficiency. Consequently, even if the emission intensity of the blue LED lamp is reduced, the luminance of the liquid crystal panel can be kept high, making it possible to achieve low power consumption of the backlight unit 56.

Note that when turning on the green LED lamp, the signal voltage V_{g} is provided only to the cyan sub-pixel C, but the wavelength dispersion of light from the green LED lamp is low. Accordingly, wavelengths of light transmitted through the cyan sub-pixel C are conceivably almost the same as those of light transmitted through the green sub-pixel G, and therefore the color reproduction range is conceivably almost the same between them.

### 5. Common Variant on the Embodiments

In the above embodiments, the RGB and RBC arrays have been described as exemplary color arrangements for color filters used in the liquid crystal display devices of the embodiments. However, these color arrangements for the color filters are not restrictive, and, for example, an RGBY, RGBYC, RGBYCM (M=magenta), YC, or YCM array may be employed. In the case where such color filters are used, the number of divisions of a field period varies in accordance with the number of colors used in the color filters.

### INDUSTRIAL APPLICABILITY

The display device of the present invention can be used as a display device capable of color display because color purity reduction can be prevented even when the transmittances of red, blue and green filters are increased. Also, in the case of the liquid crystal display device, the emission intensity of a backlight can be reduced by increasing the transmittances of the filters, and therefore use as the liquid crystal display device capable of color display is possible.

### DESCRIPTION OF THE REFERENCE CHARACTERS

12 scanning signal line driver circuit

13 data signal line driver circuit

14 liquid crystal panel

15, 55 backlight control circuit

16, 56 backlight unit

17 display element

31 to 34 red CCFL

35 to 38 green CCFL

39 to 42 blue CCFL

71 to 74 red LED lamp

75 to 78 green LED lamp

79 to 82 blue LED lamp

R, G, B, C color sub-pixel

Rf, Gf, Bf, Cf color filter

Dᵣ, D_{g}, D_{b} data signal provided to sub-pixel

D_{r′}, D_{g′}, D_{b′} part of data signal provided to sub-pixel

Vᵣ, V_{g}, V_{b} signal voltage provided to sub-pixel

V_{g′}, V_{b′} part of signal voltage provided to sub-pixel

1. An active-matrix display device capable of color display, comprising:
a display portion having a plurality of display elements arranged in a matrix, the display elements each having a plurality of types of color filters formed thereon to transmit light therethrough with a transmittance corresponding to a provided signal voltage;
a drive control portion for providing a signal voltage to the display elements having formed thereon the color filters of at least one of the types, in each of a plurality of field periods, each including first and second field periods, obtained by dividing a frame period in which to provide a display for one screen;
a backlight portion including a plurality of light emitters provided for their respective types of the color filters to emit light in a plurality of colors, the backlight portion irradiating the display portion with light by turning on the light emitters to emit light in at least one color; and
a backlight control portion for controlling the light emitters to be turned on and off independently of each other, wherein,
the color filters include first, second and third color filters, the second color filter transmitting therethrough light of shorter wavelengths than are transmitted by the first color filter and also light of some wavelengths overlapping with those transmitted by the first color filter, the third color filter transmitting therethrough light of longer wavelengths than are transmitted by the first color filter and also light of some wavelengths overlapping with those transmitted by the first color filter,
the backlight portion includes first, second and third light emitters corresponding to the first, second and third color filters, respectively,
the drive control portion provides a signal voltage to the first display element having the first color filter formed thereon in the first field period and to the second and third display elements respectively having the second and third color filters formed thereon in the second field period, and
the backlight control portion turns on the first light emitter, with the second and third light emitters being turned off, in the first field period and turns on the second and third light emitters, with the first light emitter being turned off, in the second field period.

2. The display device according to claim 1, wherein,
the display element has a function of blocking light from the light emitter when a predetermined voltage is applied thereto,
in the first field period, the drive control portion provides a signal voltage to the first display element and a light-blocking voltage to the second and third display elements,
in the second field period, the drive control portion provides a signal voltage to the second and third display elements and a light-blocking voltage to the first display element,
the backlight control portion turns on the first light emitter after a signal voltage is provided to the first display element and a voltage for blocking light from the first light emitter is provided to the second and third display elements, and
the backlight control portion turns on the second and third light emitters after a signal voltage is provided to the second and third display elements and a voltage for blocking light from the second and third light emitters is provided to the first display element.

3. The display device according to claim 2, wherein,
the first to third color filters are green, red and blue filters, respectively, and
the first to third light emitters are cold-cathode tubes for emitting green, red and blue light, respectively.

4. The display device according to claim 3, wherein the first color filter is a colorless and transparent filter.

5. The display device according to claim 1, wherein,
the display element has a function of blocking light from the light emitter when a predetermined voltage is applied thereto,
in the first field period, the drive control portion provides a signal voltage to the first display element in accordance with a part of a data signal that should be originally displayed by the first display element and a signal voltage to at least one of the second and third display elements in accordance with the rest of the data signal,
in the second field period, the drive control portion provides a signal voltage to the second and third display elements and a light-blocking voltage to the first display element,
the backlight control portion turns on the first light emitter after a signal voltage is provided to the first display element in accordance with a part of the data signal and a signal voltage is provided to at least one of the second and third display elements in accordance with the rest of the data signal, and
the backlight control portion turns on the second and third light emitters after a signal voltage is provided to the second and third display elements and the light-blocking voltage is provided to the first display element.

6. The display device according to claim 5, wherein, in the first field period, the drive control portion provides a signal voltage to the first display element in accordance with the part of the data signal and also provides a signal voltage to the second display element in accordance with the rest of the data signal when chromaticity coordinates of a color represented by the data signal are in a first area approximately at the same distance from chromaticity coordinates of first and second colors within a triangle having vertices at chromaticity coordinates of white, the chromaticity coordinates of the first color and the chromaticity coordinates of the second color, or a signal voltage to the third display element in accordance with the rest of the data signal when the chromaticity coordinates of the color represented by the data signal are in a second area approximately at the same distance from the chromaticity coordinates of the first color and chromaticity coordinates of a third color within a triangle having vertices at the chromaticity coordinates of white, the chromaticity coordinates of the first color and the chromaticity coordinates of the third color.

7. The display device according to claim 5, wherein the signal voltage in accordance with the part of the data signal is higher than the signal voltage in accordance with the rest of the data signal.

8. The display device according to claim 5, wherein,
the first to third color filters are green, red and blue filters, respectively, and
the first to third light emitters are green, red and blue LED lamps, respectively, having a plurality of green, red and blue light-emitting diodes arranged therein.

9. The display device according to claim 8, wherein the first color filter is a colorless and transparent filter.

10. The display device according to claim 1, wherein,
the display element has a function of blocking the light from the light emitter when a predetermined voltage is applied thereto,
the first color filter transmits therethrough all light transmitted through the second color filter and a part of light at wavelengths transmitted through the third color filter,
in the first field period, the drive control portion provides a signal voltage to the first display element and a light-blocking voltage to the second and third display elements,
in the second field period, the drive control portion provides a signal voltage to the second display element, a signal voltage to the third display element in accordance with a part of a data signal that should be originally displayed by the third display element, and a signal voltage to the first display element in accordance with the rest of the data signal,
the backlight control portion turns on the first light emitter after a signal voltage is provided to the first display element and a voltage for blocking light from the first light emitter is provided to the second and third display elements, and
the backlight control portion turns on the second and third light emitters after a signal voltage is provided to the second display element, a signal voltage is provided to the third display element in accordance with a part of the data signal, and a signal voltage is provided to the first display element in accordance with the rest of the data signal.

11. The display device according to claim 10, wherein the signal voltage in accordance with the part of the data signal is higher than the signal voltage in accordance with the rest of the data signal.

12. The display device according to claim 10, wherein,
the first to third color filters are cyan, red and blue filters, respectively, and
the first to third light emitters are green, red and blue LED lamps, respectively, having a plurality of green, red and blue light-emitting diodes arranged therein.

13. The display device according to claim 12, wherein the green, red and blue LED lamps have the green, red and blue light-emitting diodes provided in a delta arrangement.

14. The display device according to claim 2, wherein,
the backlight control portion turns off the second and third light emitters before turning on the first light emitter, and
the backlight control portion turns off the first light emitter before turning on the second and third light emitters.

15. The display device according to claim 2, wherein the backlight portion is divided into a plurality of blocks, each including one from each of the first to third light emitters, the blocks being partitioned by partition plates.

16. The display device according to claim 1, wherein a range of wavelengths transmitted through the second color filter overlaps a range of wavelengths transmitted through the third color filter with a minimum manufacturable width.

17. The display device according to claim 5, wherein,
the backlight control portion turns off the second and third light emitters before turning on the first light emitter, and
the backlight control portion turns off the first light emitter before turning on the second and third light emitters.

18. The display device according to claim 10, wherein,
the backlight control portion turns off the second and third light emitters before turning on the first light emitter, and
the backlight control portion turns off the first light emitter before turning on the second and third light emitters.

19. The display device according to claim 5, wherein the backlight portion is divided into a plurality of blocks, each including one from each of the first to third light emitters, the blocks being partitioned by partition plates.

20. The display device according to claim 10, wherein the backlight portion is divided into a plurality of blocks, each including one from each of the first to third light emitters, the blocks being partitioned by partition plates.
